(19) United States
(12) Patent Application Publication
(10) Pub. No.: US 2026/0093374 A1
(43) Pub. Date: Apr. 2, 2026

(54) DEVICES, METHODS, AND GRAPHICAL USER INTERFACES FOR IMMERSIVE SUPPLEMENTAL MAPS

(71) Applicant: Apple Inc., Cupertino, CA (US)

(72) Inventors: Vincent P. ARROYO, Union City, CA (US); Giovanni S. LUIS, Manhattan Beach, CA (US)

(21) Appl. No.: 19/329,420

(22) Filed: Sep. 15, 2025

Related U.S. Application Data
(60) Provisional application No. 63/700,646, filed on Sep. 28, 2024.

(51) Int. Cl. G06F 3/04815; G06F 9/451

(52) U.S. Cl. CPC G06F 3/04815; G06F 9/451

(57) ABSTRACT

Some embodiments of the disclosure are directed to systems and methods for generating supplemental map experiences. In some embodiments, a computer system detects information while physically located within a physical environment. In some embodiments, a computer system associates detected information with a supplemental map that corresponds to a geographic region within a physical environment. In some embodiments, a computer system presents a representation of a supplemental map including information detected while physically located in a geographic region corresponding to the supplemental map.

### CROSS-REFERENCE TO RELATED APPLICATIONS

This application claims the benefit of U.S. Provisional Application No. 63/700,646, filed Sep. 28, 2024, the content of which is incorporated herein in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system is physically located within a physical environment. In some embodiments, a computer system associates information with a supplemental map that corresponds to a region that a user of the computer system is located within relative to the physical environment. In some embodiments, the information includes images, video, audio, and/or other virtual content. In some embodiments, the computer system presents an immersive virtual reproduction such as a virtual three-dimensional environment using the information associated with the supplemental map. In this way, the computer system optionally creates rich and interactive map experiences, reducing the time and power consumption required to craft such experiences manually on-device.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7N illustrate examples of a computer system generating and presenting supplemental maps in accordance with some embodiments.

FIG. 8 is a flow diagram illustrating a method of generating and presenting supplemental maps in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system is physically located within a physical environment. In some embodiments, a computer system associates information with a supplemental map that corresponds to a region that a user of the computer system is located within relative to the physical environment. In some embodiments, the information includes images, video, audio, and/or other virtual content. In some embodiments, the computer system presents an immersive virtual reproduction such as a virtual three-dimensional environment using the information associated with the supplemental map. In some embodiments, the computer system generates a plurality of supplemental maps, each corresponding to different geographic regions. In some embodiments, the computer system presents the virtual three-dimensional environment that mimics the physical environment the computer system was moving within, which includes the information captured while generating a supplemental map.

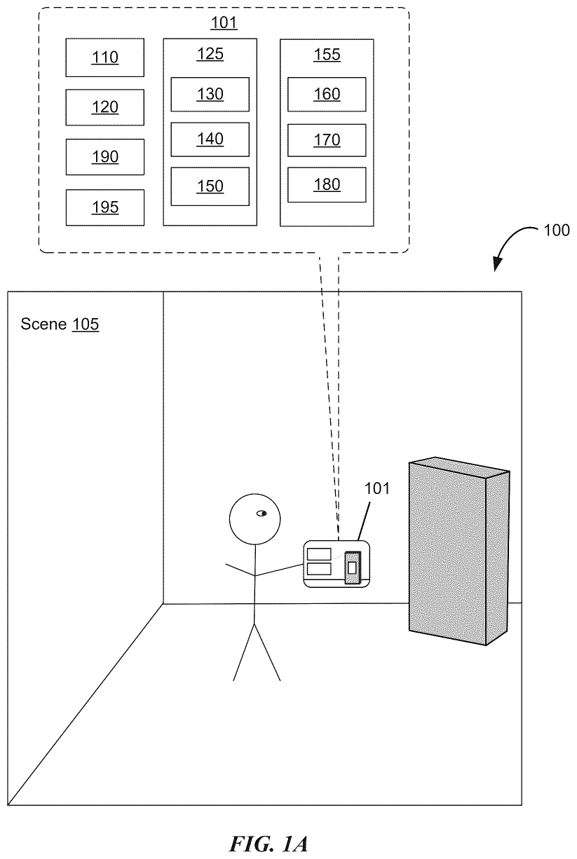

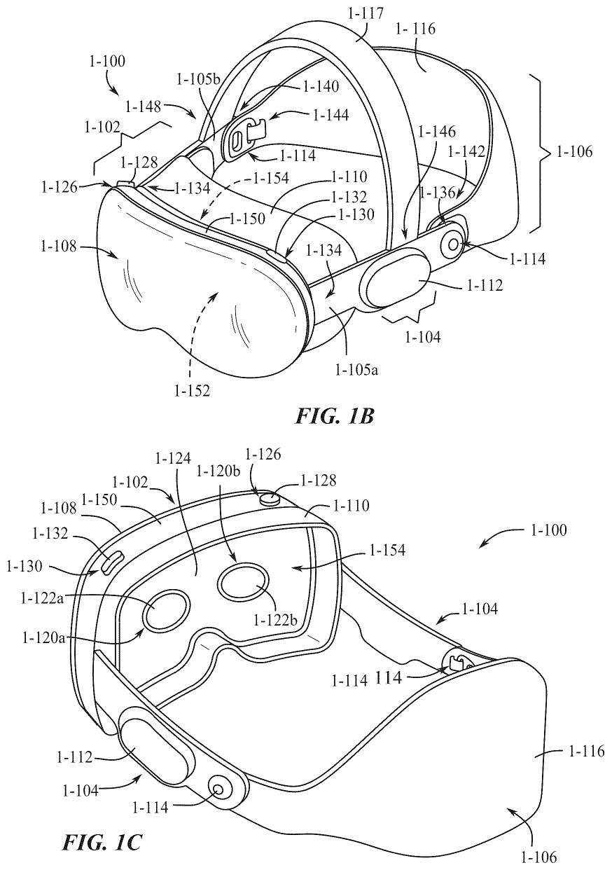

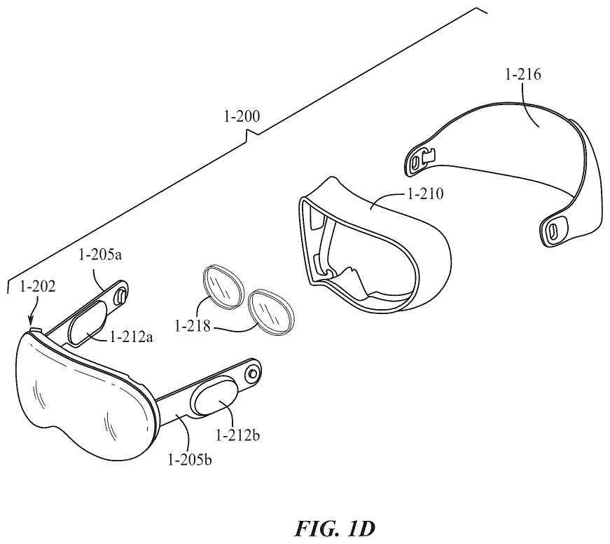

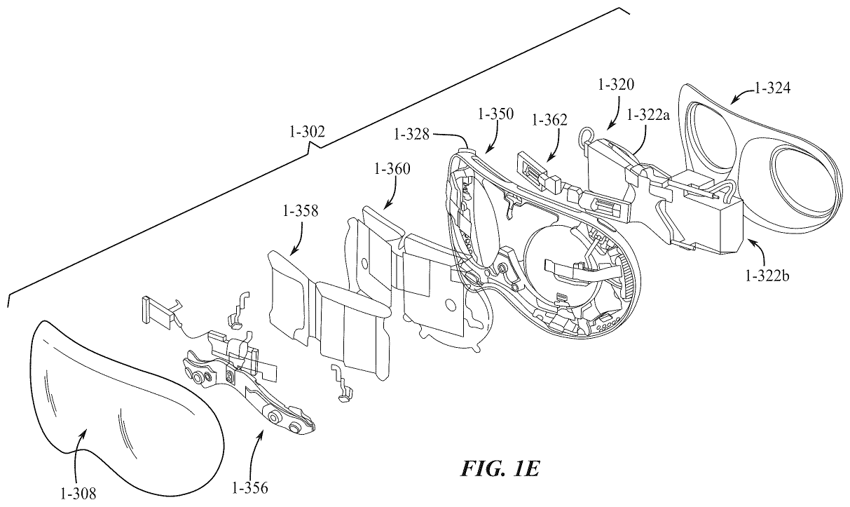

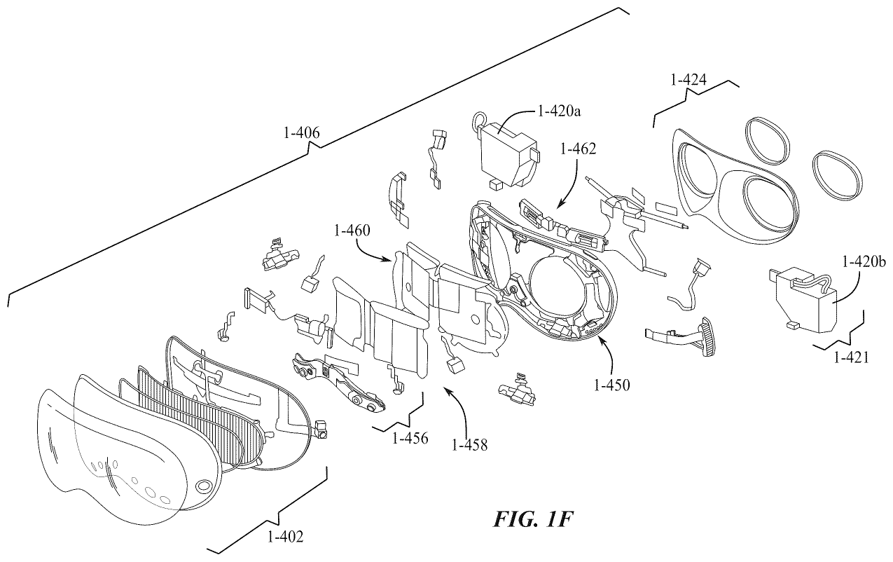

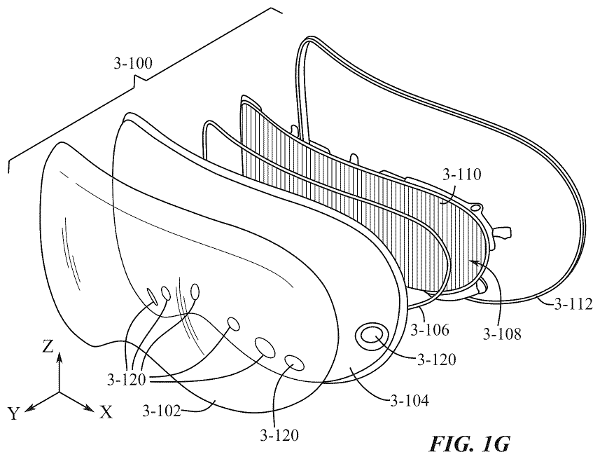

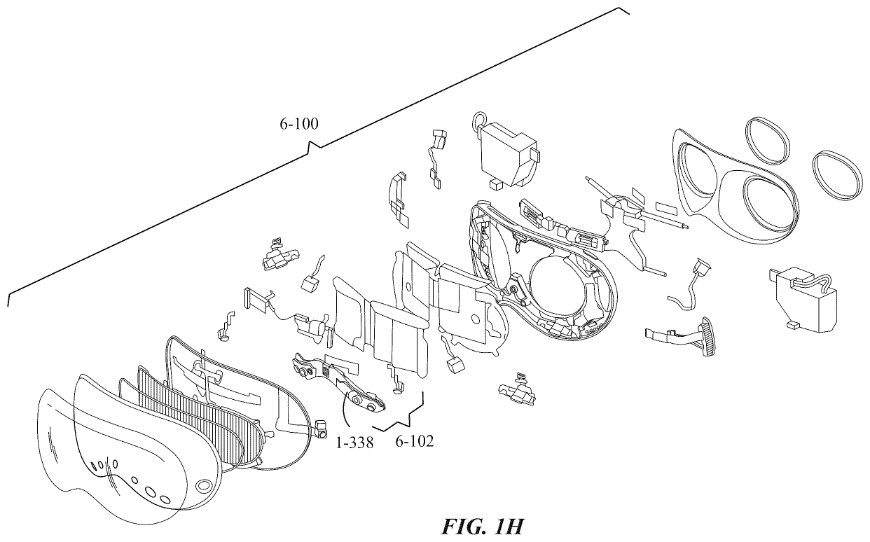

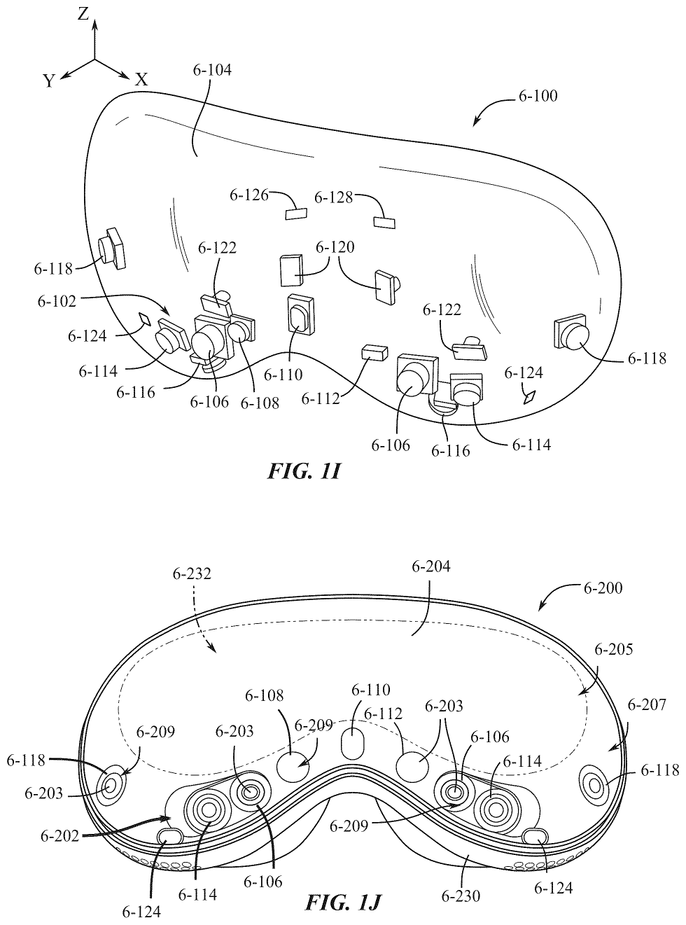

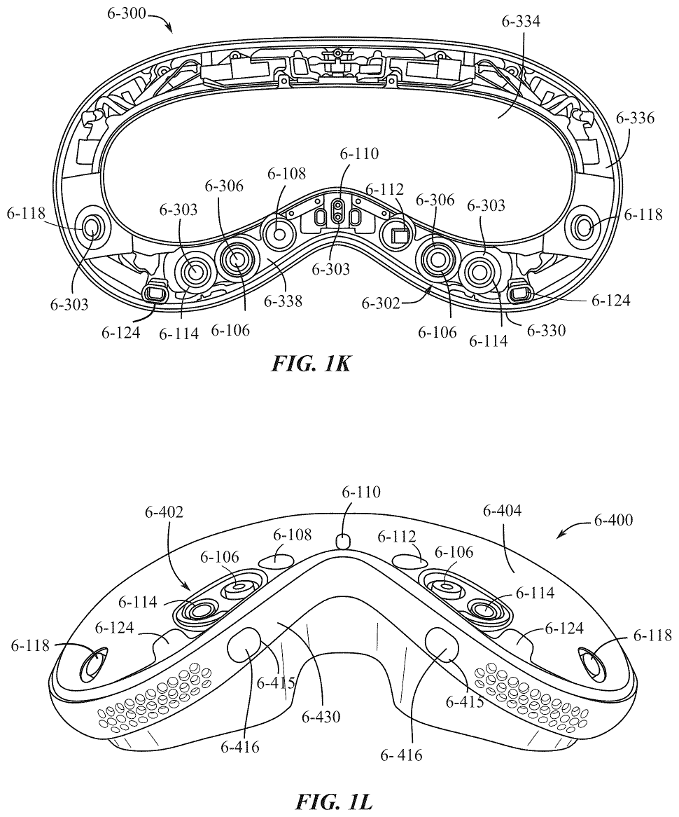

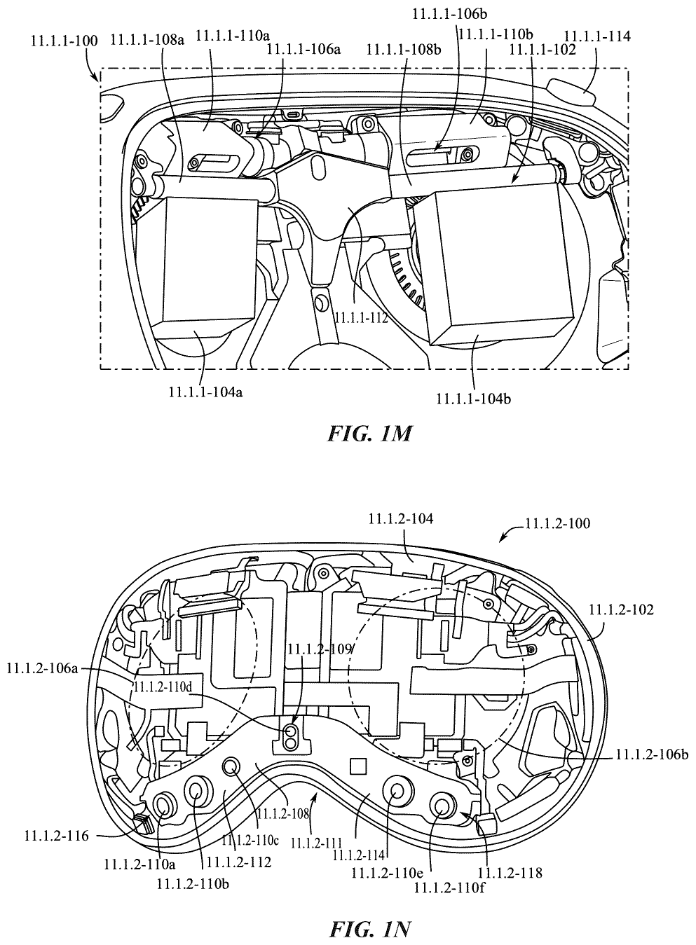

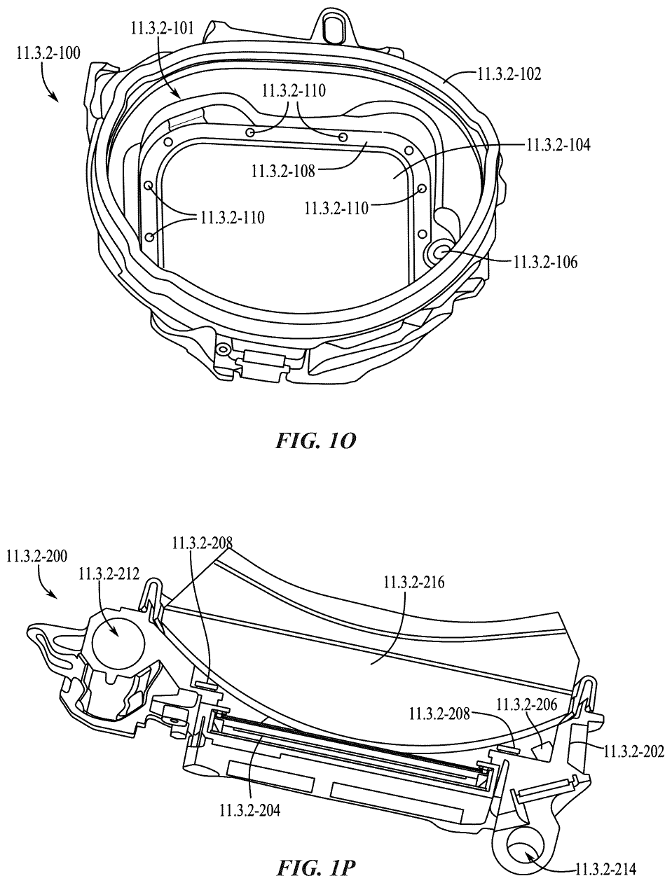

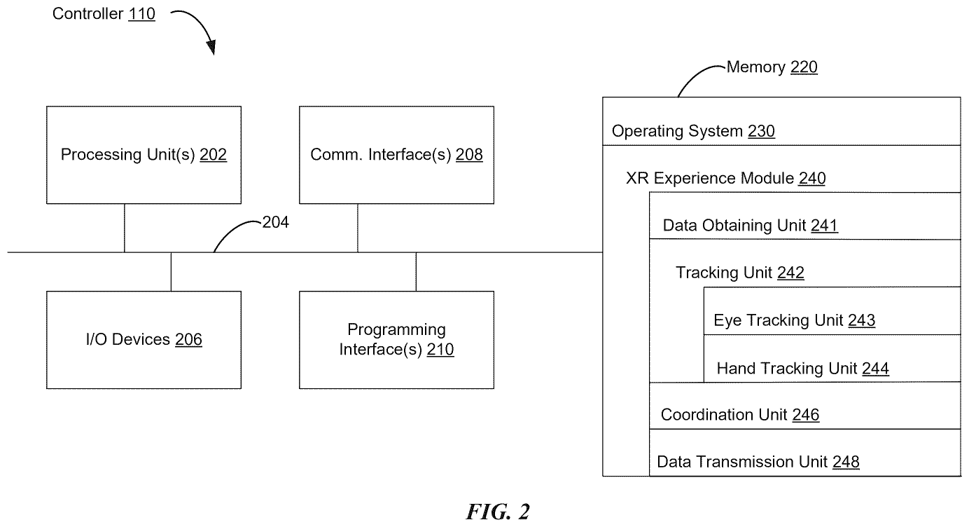

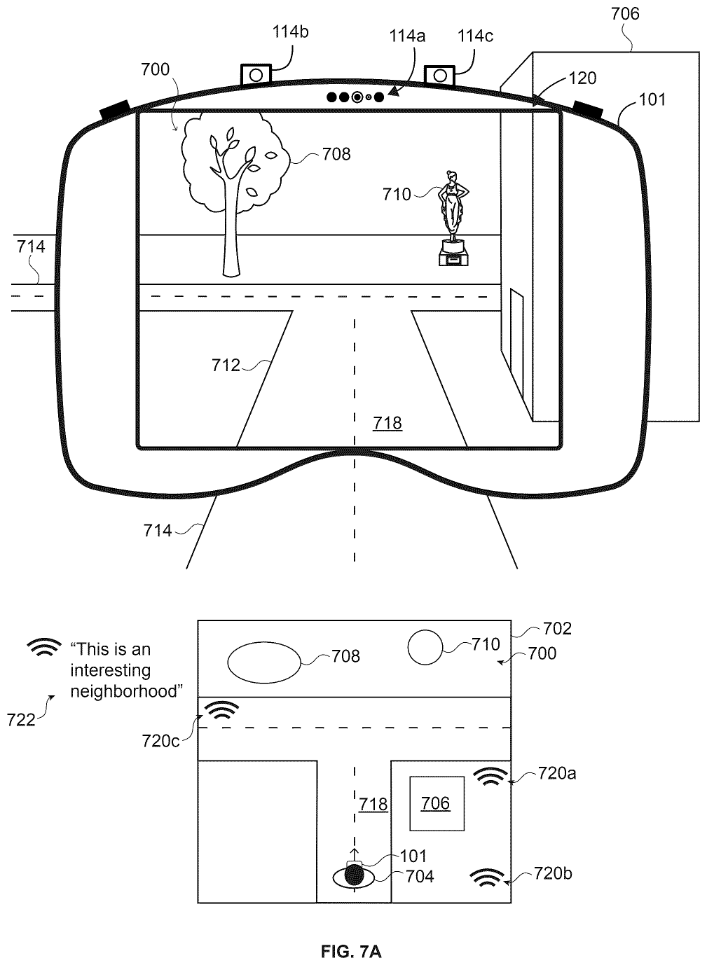

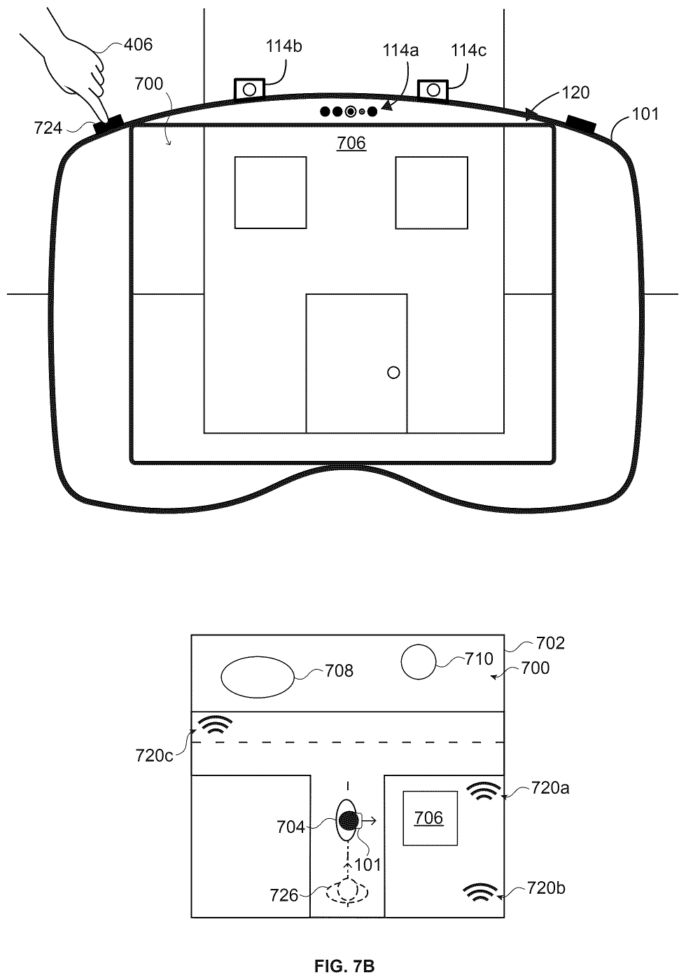

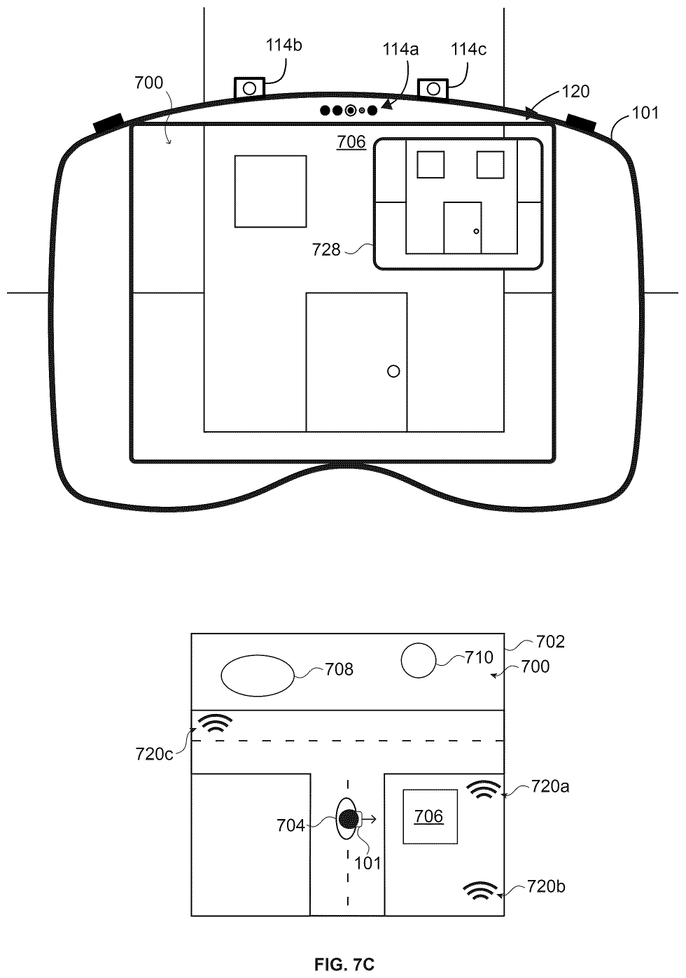

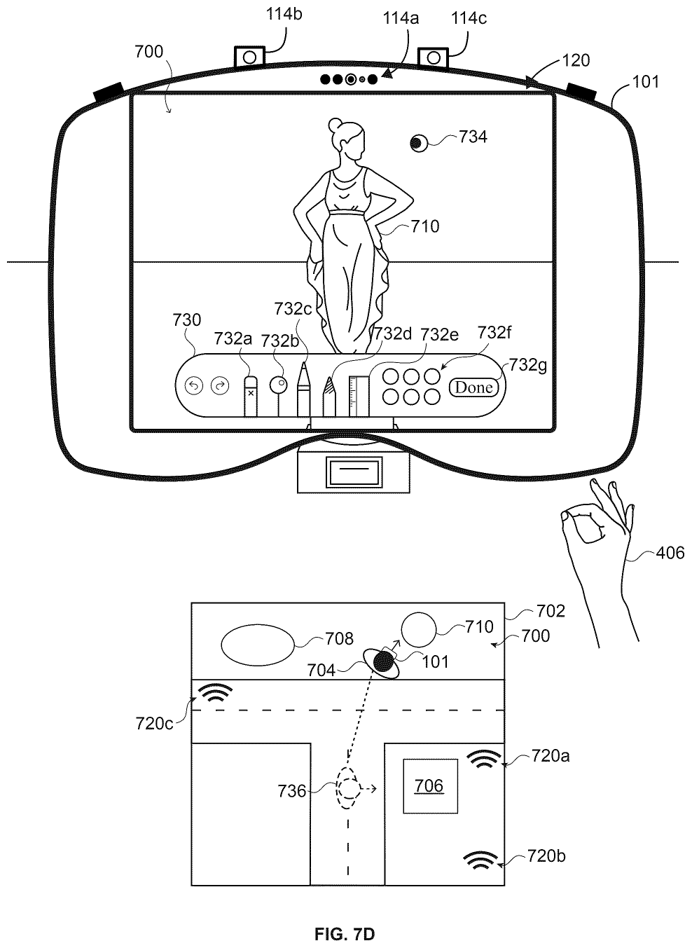

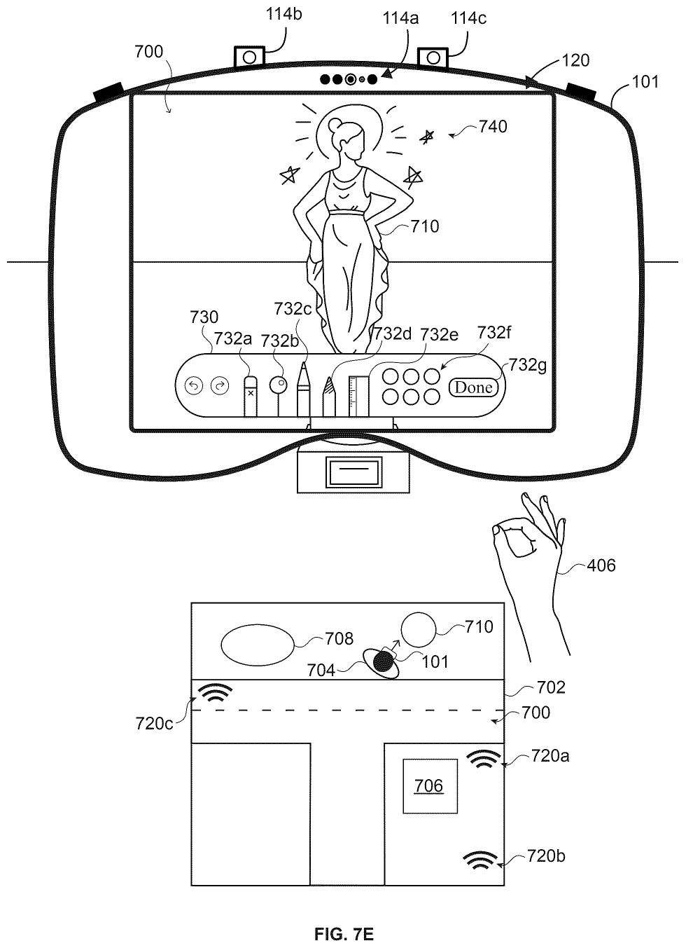

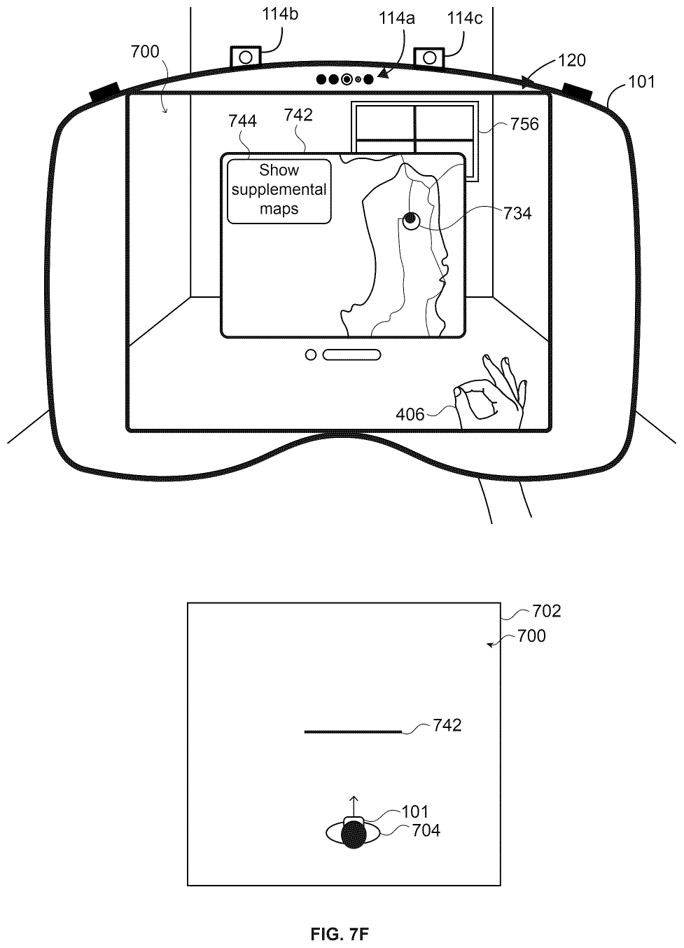

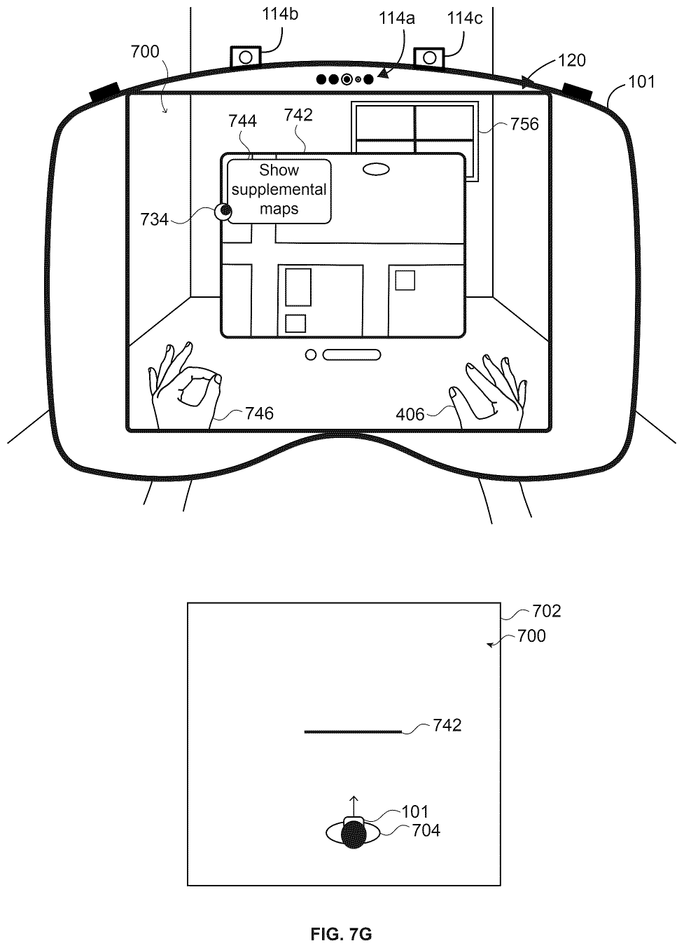

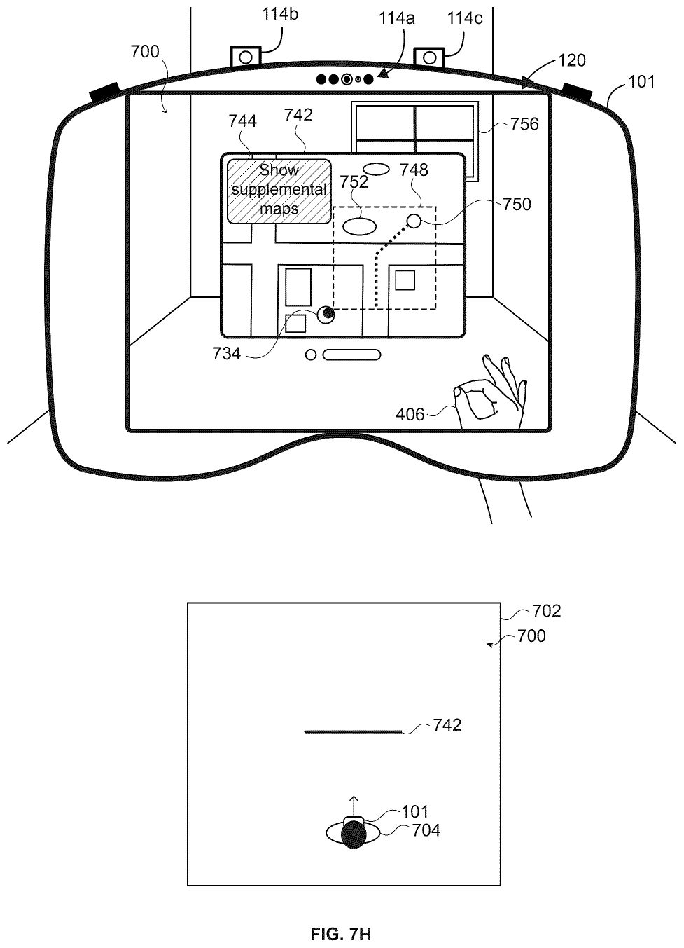

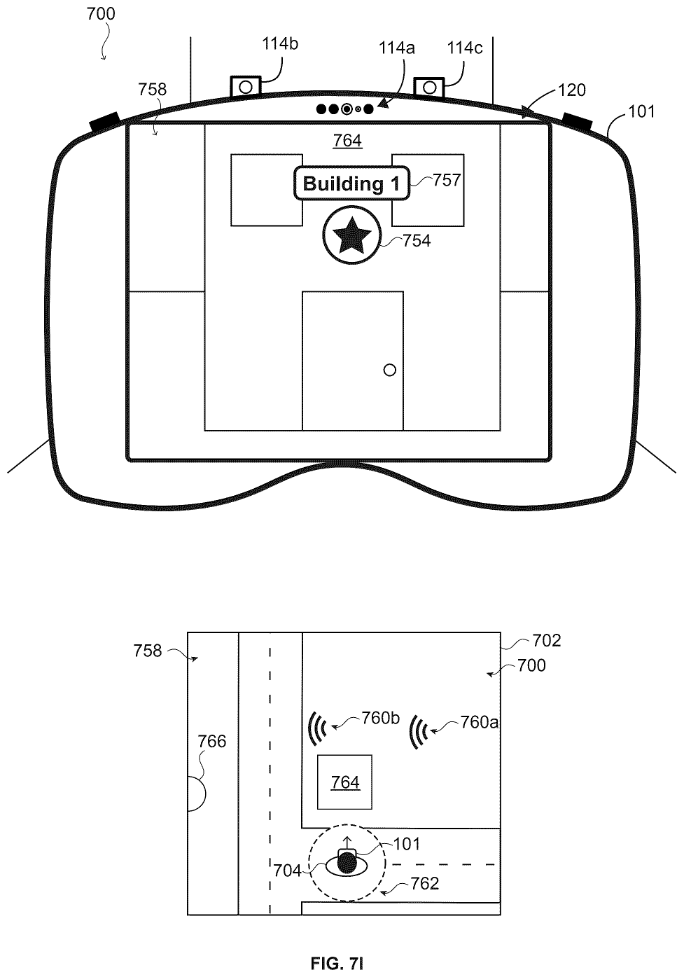

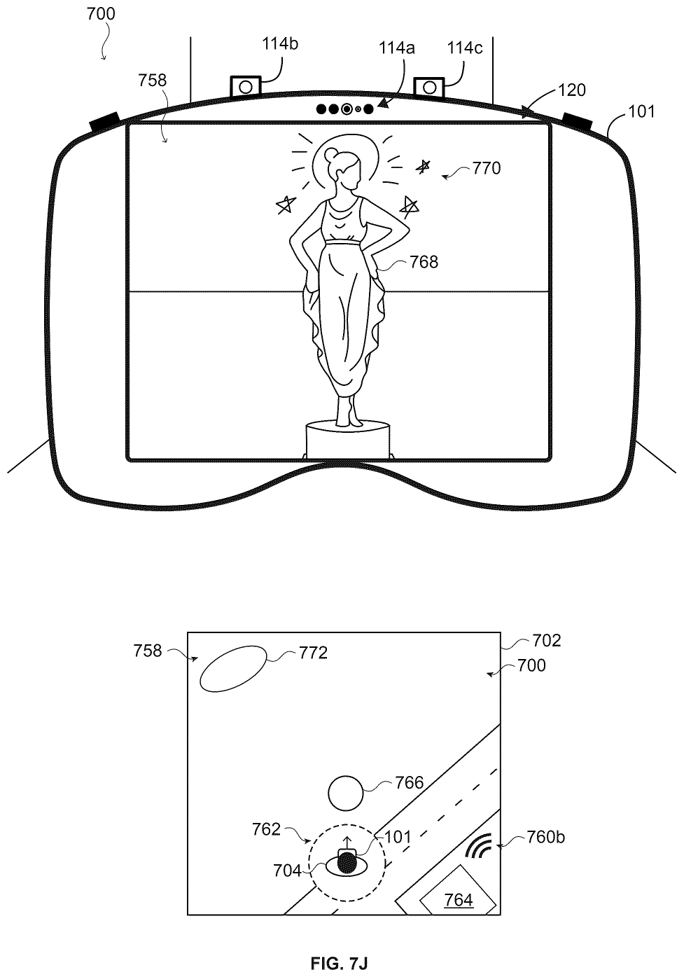

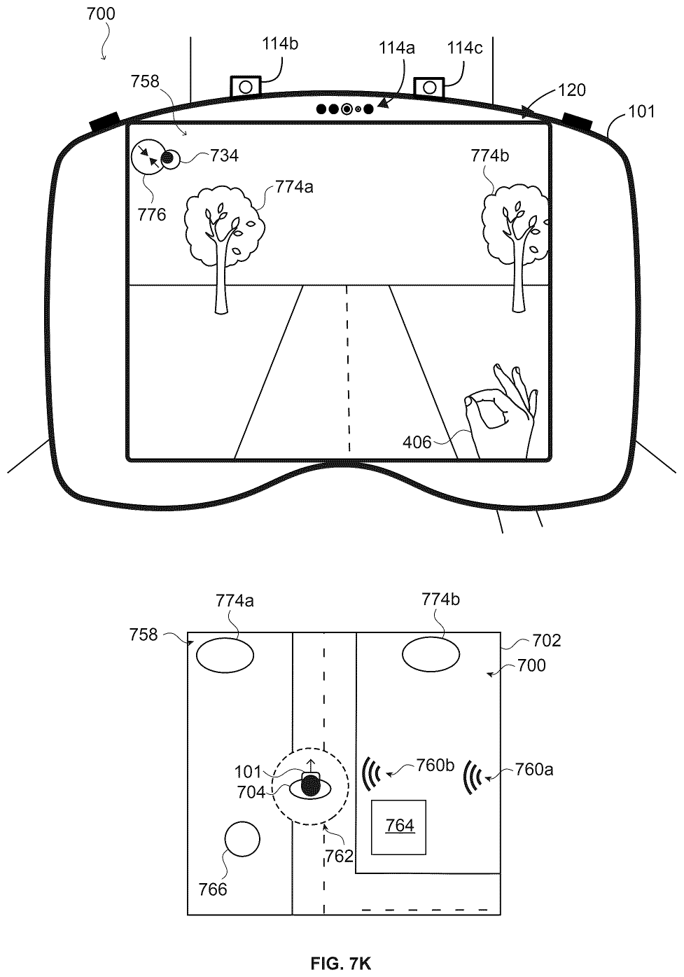

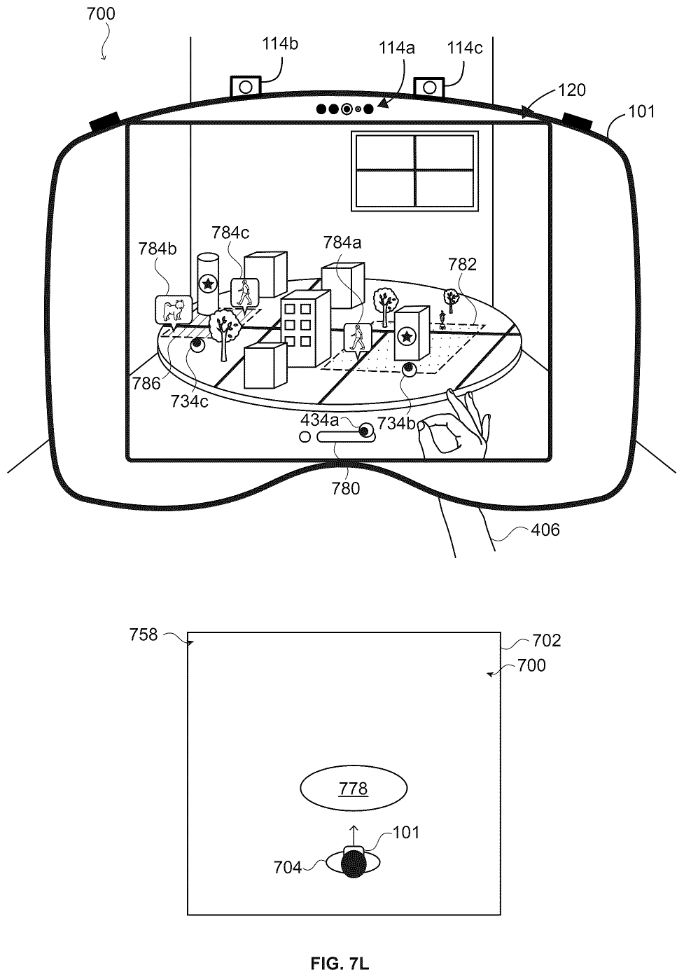

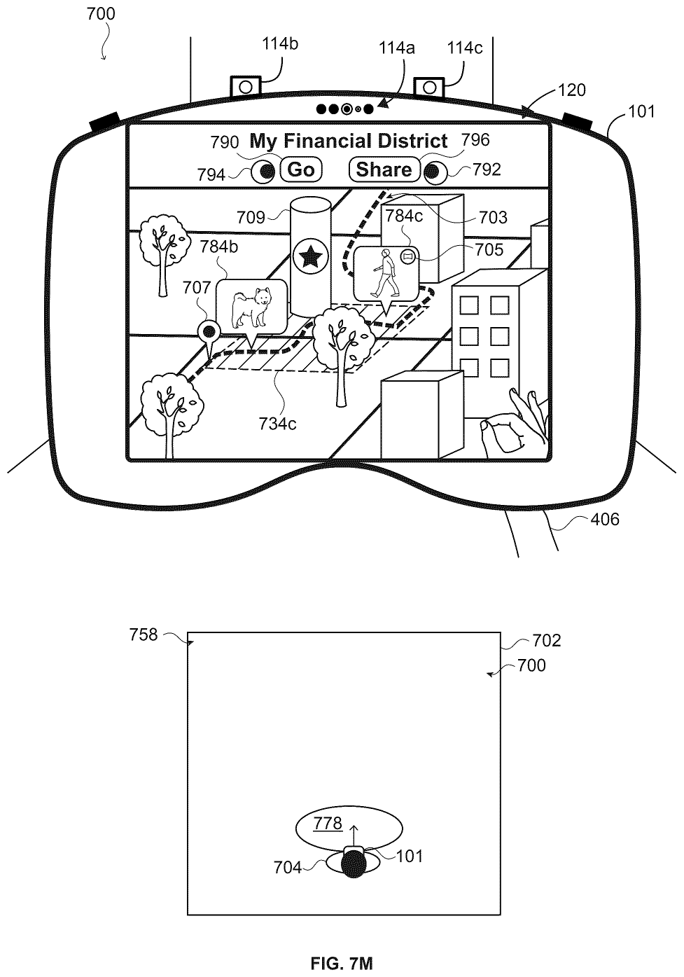

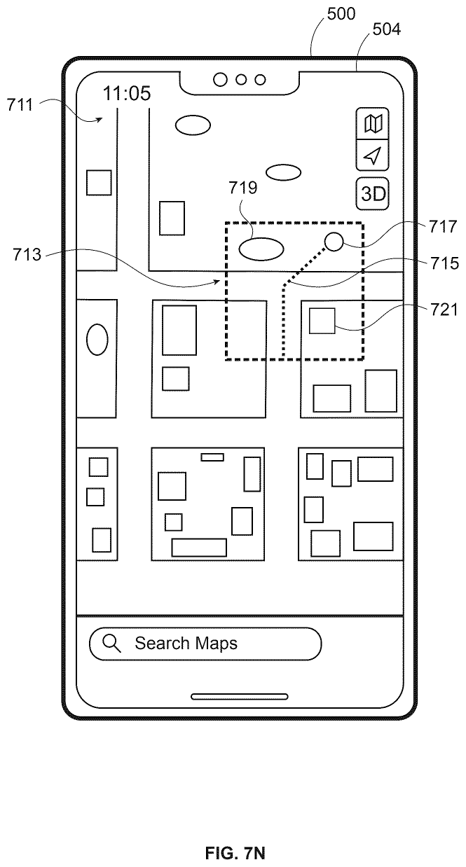

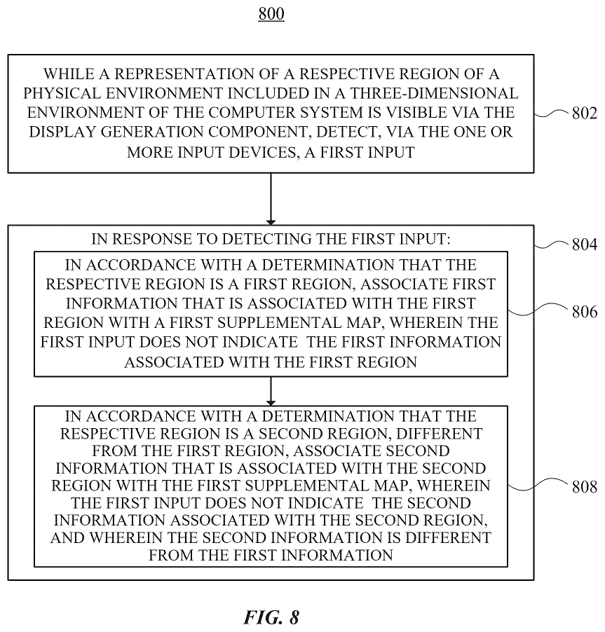

FIGS. 1A-6 provide a description of example computer systems for providing XR experiences to users (such as described below with respect to method 800). FIG. 7A-7N illustrate examples of a computer system generating and presenting supplemental maps in accordance with some embodiments. FIG. 8 is a flow diagram illustrating a method of generating and presenting supplemental maps in accordance with some embodiments. The user interfaces in FIGS. 7A-7N are used to illustrate the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

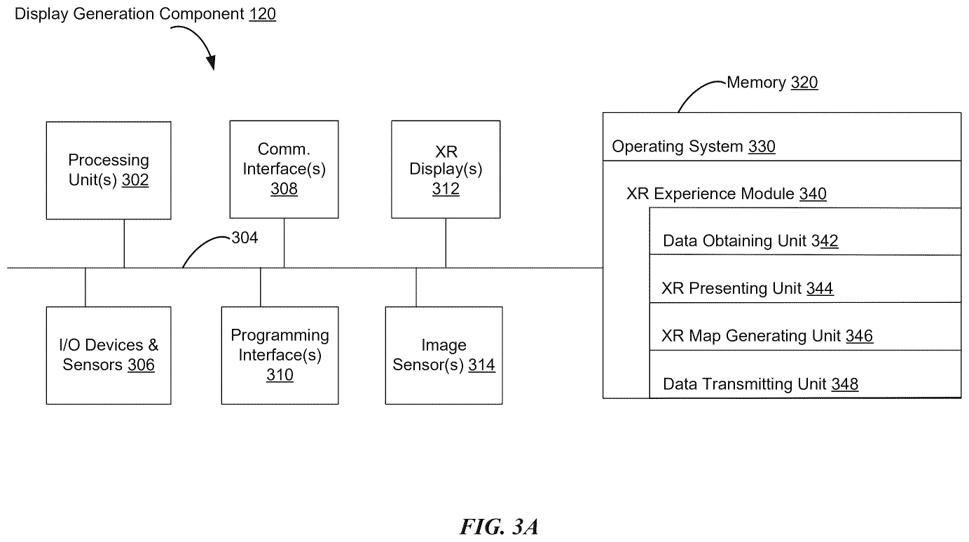

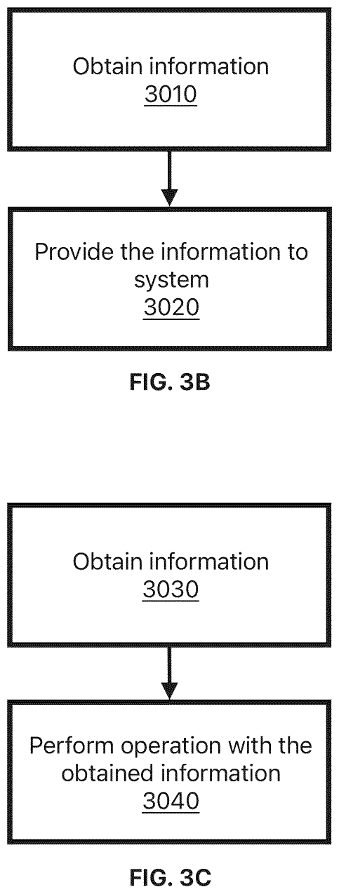

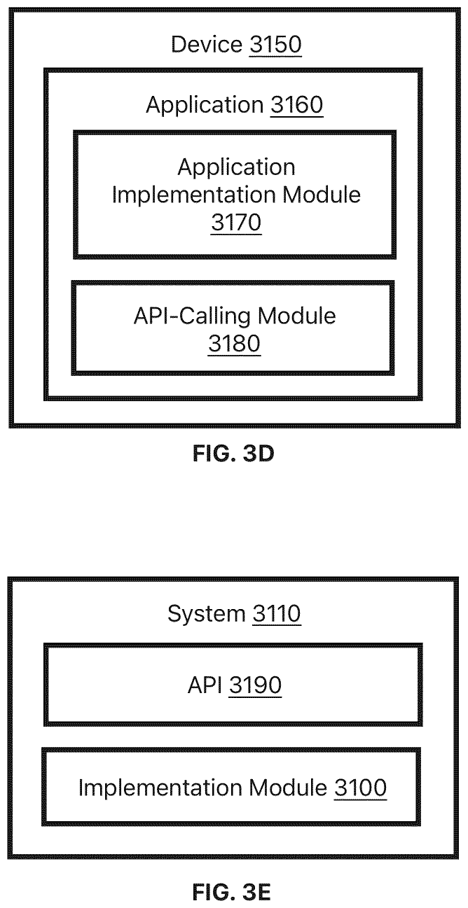

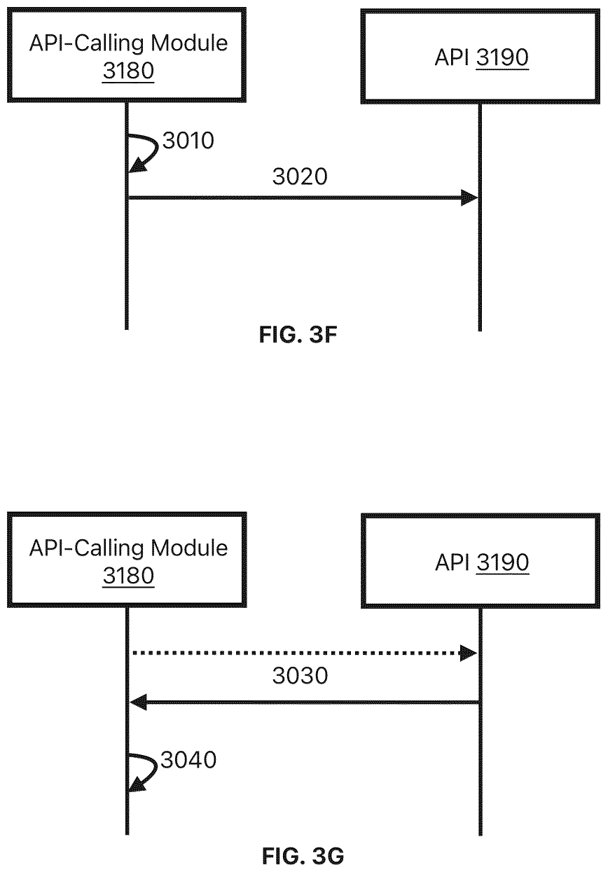

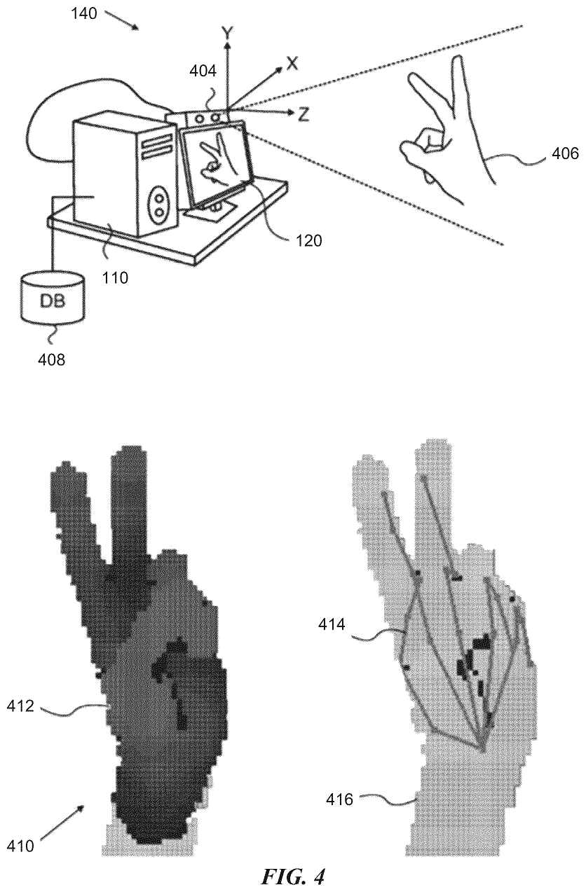

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIG. 1D-1F and described herein. Likewise, any of the features, components, and/or parts, including the arrangements and configurations thereof shown and described with reference to FIG. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIG. 1B-1D and 1F and described herein. Likewise, any of the features, components, and/or parts, including the arrangements and configurations thereof shown and described with reference to FIG. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIG. 1B-1E as well as subsequent figures referenced in the present disclosure. The display unit 1-406 shown in FIG. 1F can be assembled and integrated with the securement mechanisms shown in FIG. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIG. 1B-1E and described herein. Likewise, any of the features, components, and/or parts, including the arrangements and configurations thereof shown and described with reference to FIG. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J.

Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIG. 1J-1L and described herein. Likewise, any of the features, components, and/or parts, including the arrangements and configurations thereof shown and described with reference to FIG. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIG. 1I-1J and 1L and described herein. Likewise, any of the features, components, and/or parts, including the arrangements and configurations thereof shown and described with reference to FIG. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIG. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIG. 1I-1K and described herein. Likewise, any of the features, components, and/or parts, including the arrangements and configurations thereof shown and described with reference to FIG. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users'eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

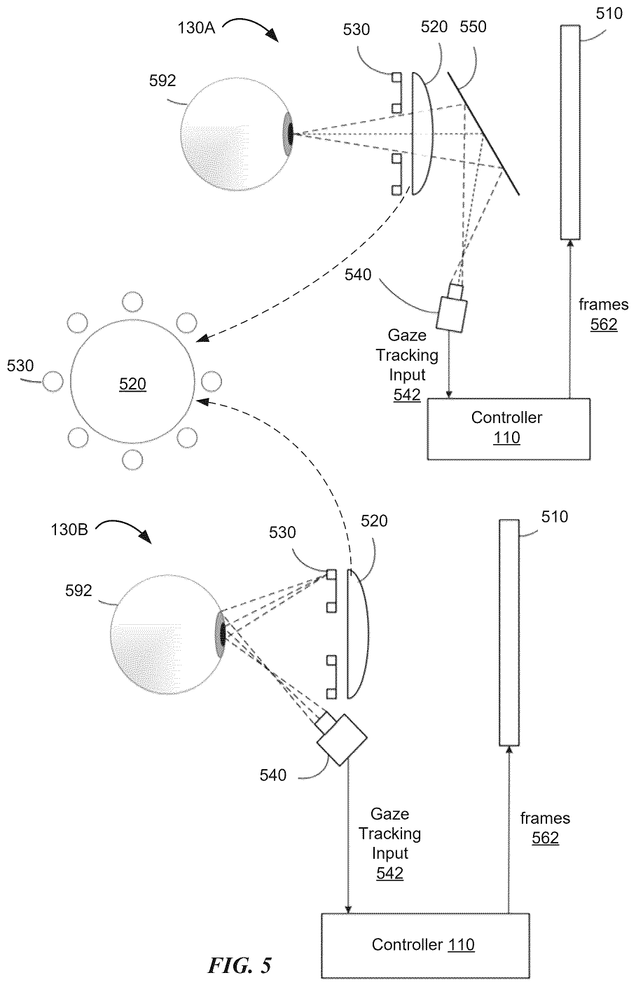

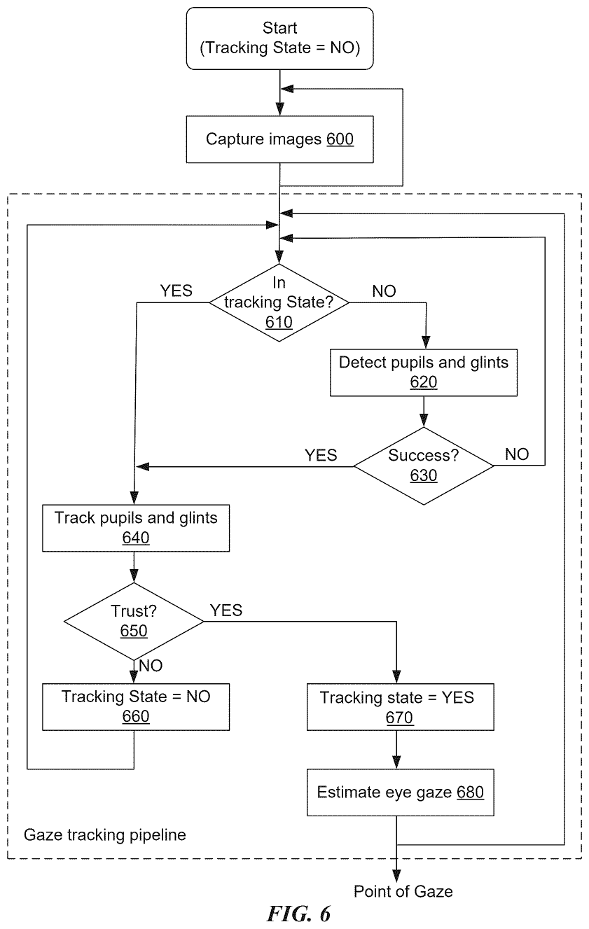

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior-and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100.

Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each eye lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5).

The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES”and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

Some embodiments of the disclosure are directed to generating spatial supplemental maps. FIGS. 7A-7N illustrate examples of a computer system presenting supplemental maps in accordance with some embodiments.

FIG. 7A illustrates a computer system 101 (e.g., an electronic device) displaying, via a display generation component (e.g., display generation component 120 of FIG. 1A and/or display generation components 1-122a and 1-122b of FIG. 1C), a three-dimensional environment 700 from a viewpoint of a user of the computer system 101. In FIG. 7A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100 of FIG. 1A), including one or more objects in the physical environment around computer system 101. In some embodiments, computer system 101 displays representations of the physical environment in three-dimensional environment 700.

As discussed in more detail below, in some embodiments, display generation component 120 is illustrated as displaying one or more virtual objects in the three-dimensional environment 700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of any of the virtual content shown in FIGS. 7A-7N.

Display generation component 120 has a field of view (e.g., a field of view captured by external image sensors 114b and 114c and/or visible to the user via display generation component 120) that corresponds to the virtual objects shown in FIGS. 7A-7N. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

FIG. 7A illustrates a computer system 101 presenting visibility of a physical environment in a three-dimensional environment 700. A three-dimensional environment, as described above, optionally includes the physical and/or virtual portions of the three-dimensional environment. In FIG. 7A, computer system 101 presents a representation of the physical environment, which optionally is visible via an at least partially transparent material and/or is reproduced by one or more cameras such as image sensors 114b-c and displayed via display generation component 120.

In FIG. 7A, the physical environment includes a plurality of physical elements such as physical objects. Building 706, statue 710, and tree 708, for example, are visible via display generation component 120 and exist in the physical environment of user 704. Additionally, road 718 is visible, which include a first portion 712 visible via display generation component 120, and a second portion 714 and a third portion 716 that are visible outside a viewport of the display generation component 120. In some embodiments, while presenting representations of the physical environment, computer system 101 displays a user interface for creating and/or interacting with maps. In some embodiments, computer system 101 performs some or all the operations described with reference to FIGS. 7A-7E without displaying some or all user interface elements included in the user interface for creating and/or interacting with maps.

In some embodiments, computer system 101 detects an input that is optionally associated with a request to generate a supplemental map. For example, as shown in FIG. 7A, computer system 101 detects voice command 722 (e.g., “this is an interesting neighborhood”) while the above-described user interface for creating a map is not displayed. In some embodiments, in response to detecting the input, computer system 101 initiates collection of information. In some embodiments, computer system 101 associates the collected information with a supplemental map, as described with reference to method 800. The supplemental map, for example, optionally includes one or more layers of data that computer system 101 is able to present to user 704, such as a collection of routes, objects, and/or other spatial information used to graphically represent a geographic region and/or contents of the geographic region.

Additionally or alternatively, the supplemental map optionally includes additional spatial information, such that computer system 101 is capable of presenting a virtual recreation of the geographic region with a level of immersion (e.g., described with reference to method 800). Additionally or alternatively, the supplemental map optionally includes information and/or content based on interactions between user 704 and three-dimensional environment 700 collected in response to and/or after detecting the input (e.g., voice command 722).

Turning back to voice command 722, computer system 101 in FIG. 7A detects that the voice command indicates potential interest in creating a supplemental map due to interest expressed by user 704 in a current neighborhood of user 704. In response to detecting voice command 722, computer system 101 optionally initiates collection of spatial and/or visual information that optionally is used to recreate the geographic environment shown in the top-down 702 view of three-dimensional environment 700. For example, computer system 101 optionally stores image data based on the portions of tree 708, road 718, and/or building 706 visible via display generation component 120. Additionally or alternatively, computer system 101 detects image and/or spatial data representative of the appearance and/or contours of the physical environment not displayed and/or outside of the portion of the physical environment represented via display generation component 120 as shown in FIG. 7A.

In some embodiments, in response to detecting voice command 722, computer system 101 additionally or alternatively detects and/or stores audio. As shown in FIG. 7A, computer system 101 detects audio 720a, audio 720b, and/or audio 720c, which optionally are ambient noises within three-dimensional environment 700. In some embodiments, audio 720a-c have locations within the physical environment that are detected by computer system 101 and/or determined by computer system 101 and computer system optionally stores spatial information that is optionally used to recreate the sensation of audio 720a-c being presented from a location within three-dimensional environment 700. In some embodiments, computer system 101 continues to detect spatial, video, and/or audio information initiated in response to detecting voice command 722 until user 704 provides an input requesting ceasing of the detecting, leaves a certain geographic area, and/or until one or more criteria are satisfied.

FIG. 7B illustrates computer system 101 detecting input requesting storing and/or associating visual and/or spatial information with the supplemental map. For example, in FIG. 7B, the detecting of information to store within and/or associated with a supplemental map is ongoing. From FIG. 7A to FIG. 7B, the viewpoint of user 704 physically moves relative to three-dimensional environment 700 (e.g., relative to the physical environment of the user), from first viewpoint 726 to the viewpoint shown in FIG. 7B. Additionally, computer system 101 optionally detects an input requesting adding information that potentially is added to the supplemental map for the region of the physical environment that user 704 is within. For example, in FIG. 7B computer system 101 detects hand 406 selecting a button 724. It is understood, however, that additional or alternative inputs are contemplated, as described at least with reference the “second input” when describing method 800 herein.

FIG. 7C illustrates display of information that computer system 101 is able to associate with a supplemental map. For example, in response to the input shown in FIG. 7B, computer system 101 captures visual and/or spatial information indicative of building 706 based on the viewpoint of user 704 shown in FIG. 7B-7C. In response to detecting the input in FIG. 7B, computer system 101 displays image 728, which optionally corresponds to the viewport of computer system 101 in FIG. 7B. Image 728 optionally is representative of the visual information captured, and is optionally a two-dimensional and/or three-dimensional screenshot overlaying the three-dimensional environment 700. It is understood that examples described herein that refer to two-dimensional images and/or screenshots can additionally or alternatively include or correspond to three-dimensional images and/or screenshots, such as when computer system 101 detects three-dimensional image data and displays a three-dimensional image depicting the image data.

FIG. 7D illustrates display of a user interface for inserting virtual annotations which are optionally associated with a supplemental map. For example, from FIG. 7C to FIG. 7D, computer system 101 detects the viewpoint of user 704 move relative to three-dimensional environment 700 from second viewpoint 736 to third viewpoint 738. Accordingly, computer system 101 in FIG. 7D presents statue 710 while computer system 101 is directed toward statue 710. In FIG. 7D, computer system 101 displays a palette 730, which optionally includes one or more selectable options that are individually selectable to cause performance of one or more operations to change characteristics of an annotation tool and/or display information for creating a virtual annotation.

Palette 730 includes a plurality of selectable options. For example, palette 730 includes eraser 732a, pin 732b, pencil 732c, marker 732d, ruler 732e, colors 732f, and selectable option 732g. In response to detecting selection input respectively selecting eraser 732a, pin 732b, pencil 732c, or marker 732d, computer system 101 optionally selects a currently active simulated tool. Additionally or alternatively, computer system 101 optionally displays a visual indication of the currently active tool, such as an eraser-shaped cursor, a pin-shaped cursor, a pencil tip cursor, or a marker tip cursor. As shown in FIG. 7E, computer system 101 optionally detects input entering simulated drawings and/or writing, and optionally displays a virtual annotation in accordance with the input and/or the selected tool (e.g., as described with reference to FIG. 7E the input is optionally an air pinching of two fingers). Ruler 732e, when selected, optionally causes display of a ruler overlaying three-dimensional environment 700 optionally used to guide and/or orient the simulated drawings. Colors 732f optionally are selectable to change the color of simulated markings and/or virtual pins that are inserted into the three-dimensional environment 700. Selectable option 732g is optionally selectable to cease display of palette 730 and/or optionally cease entry of virtual annotations in accordance with simulated drawing and/or writing.

It is understood that in general, computer system 101 optionally detects input, and in response, is optionally able to perform operations. Thus, when describing that a selectable option is “selectable” to cause some behavior and/or operation, it is understood that computer system 101 optionally detects an input directed toward the selectable option (e.g., an air pinch while attention is directed toward the selectable option as described with reference to FIG. 7E), and in response to detecting the input, optionally performs one or more operations described with reference to the selectable option. For example, the selectable options included in palette 730 are optionally selectable to activate and/or select a current virtual annotation tool.

Additionally, from FIG. 7C to FIG. 7D, computer system 101 ceases display of the screenshot shown in FIG. 7C (e.g., a two and/or three-dimensional screenshot), in response to detecting a user provide input air pinching, air swiping, a voice command, and/or selecting a physical or virtual selectable option such as a button directed toward the screen shot, and/or that a period of time has passed without detecting user input directed toward the screenshot greater than a threshold amount of time (e.g., 1, 1.5, 2, 2.5, 3, 3.5, 5, 6.5, 8, or 10 seconds).

In FIG. 7D, computer system 101 detects an attention 734 directed toward a position within three-dimensional environment 700. Concurrently, computer system 101 in FIG. 7D detects input from hand 406, including an air pinching of two fingers, and in response, optionally initiates a simulated marking annotation which optionally is stored and/or associated with the ongoing collection of information for the supplemental map.

FIG. 7E illustrates display of a virtual annotation 740 in accordance with input provided by user 704. For example, from FIG. 7D to FIG. 7E, computer system 101 optionally detects a series of movements of hand 406, a ceasing and/or re-initiating of the air pinch, and/or some combination thereof. In some embodiments, the virtual annotation 740 includes simulated drawings, as shown in FIG. 7E. Computer system 101, for example, optionally initiates display of virtual annotation 740 corresponding to where attention was directed in FIG. 7D, and/or extends the drawing in one or more directions and/or by one or more amounts in accordance with one or more directions and/or by one or more amounts of movement of hand 406 while an air pinch is maintained. In response to detecting a ceasing of the air pinch, computer system 101 optionally repeats one or more of the detecting of attention, initiating of an air pinch, moving of the hand, and/or ceasing of the air pinch to draw additional marks included in virtual annotation 740. In response to detecting selection of 732g, computer system 101 optionally saves and/or stores virtual annotation 740, and/or associates the virtual annotation 740 with the supplemental map that is being generated. For example, computer system 101 optionally stores the spatial information indicating the spatial relationship between the markings included in virtual annotation 740 relative to the physical environment and/or the statue 710, which are optionally used to display a virtual recreation of the virtual annotation 740 relative to a virtual equivalent of statue 710 having a similar or same spatial relationship as shown in FIG. 7E.

As described with reference to method 800, computer system 101 optionally detects additional or alternative inputs than those shown from FIG. 7A-7E, and optionally associates further information with the supplemental map. In some embodiments, the collection of information is based upon a determined context. For example, in response to detecting the selection of button 724 shown in FIG. 7B, computer system 101 optionally initiates a voice recording in accordance with a determination that a user is speaking and/or that the viewpoint of user 704 is not directed toward a landmark and/or a physical point of interest (e.g., is not directed toward building 706 as shown in FIG. 7B). Additionally or alternatively, computer system 101 optionally records a video and/or a spatial video in response to detecting the selection of button 724 in accordance with a determination that a velocity of the user corresponds to movement while running, biking, driving, and/or traveling on public transportation. Thus, computer system 101 optionally records information for the supplemental map in accordance with context of user 704, and optionally forgoes recording of information less likely to be relevant to user 704.

FIG. 7F illustrates a maps user interface according to some examples of the disclosure. In FIG. 7F, three-dimensional environment 700 changes, as user 704 moves to a different physical environment as indicated by window 756. In some embodiments, computer system 101 displays a user interface for a maps application. In some embodiments, the user interface facilitates presentation of maps, including supplemental maps. For example, virtual object 742 optionally includes the maps user interface, which in FIG. 7F illustrates a map of a geographic region such as a city. Virtual object 742 in FIG. 7F includes a selectable option 744, which when selected, optionally causes display of one or more supplemental map layers overlaying the presented map of the geographic region. In FIG. 7F, computer system 101 detects input provided by hand 406 while attention 734 is directed toward the portion of the geographic region presented in virtual object 742.

In some embodiments, computer system 101 displays selectable option 744 in accordance with a determination that a portion of a map represented in the maps application user interface corresponds to a region associated with a supplemental map. For example, in FIG. 7F, computer system 101 displays selectable option 744 in accordance with a determination that the displayed portion of the map overlaps with at least a portion of a boundary of a supplemental map (e.g., the supplemental map generated as shown from FIG. 7A through FIG. 7E). Additionally or alternatively, in accordance with a determination that the displayed portion of the map does not overlap with the boundary, computer system 101 optionally forgoes display of selectable option 744. For example, computer system 101 determines user 704 was physically moving and/or proximate to a region within a map, and generates the supplemental having a boundary that surrounds that region within the map. In FIG. 7F, because the displayed portion of the map coincides with the region within the map, computer system 101 optionally displays selectable option 744.

From FIG. 7F to FIG. 7G, computer system 101 detects a separating of fingers included in hand 406, and in response, scales the maps user interface included in virtual object 742. In some embodiments, computer system 101 detects a repeating of the pinching and/or separating, and successively scales the maps user interface in accordance with each separating of the fingers. In FIG. 7G, computer system 101 detects attention 734 target selectable option 744 concurrently while computer system 101 detects hand 746 direct an air pinch.

In FIG. 7H, computer system 101 initiates display of a supplemental map layer. From FIG. 7G to FIG. 7H, computer system 101 displays layer 748 overlaying the maps user interface in response to detecting the input shown in FIG. 7G with hand 746. Layer 748 optionally includes a border, indicated by a dashed line, indicative of the boundary of the supplemental map generated from FIG. 7A-7E. In FIG. 7H, layer 748 is positioned relative to the map at a region corresponding to where user 704 physically moved and/or was located while generating the supplemental map (and/or is not positioned and/or does not include portions of the map where the user did not visit physically).

Layer 748 further includes representations of objects that were present in the physical environment of user 704 while generating the supplemental map information but were not displayed in the base map layer shown in FIG. 7G, such as object 750 (e.g., corresponding to statue 710) and object 752 (e.g., corresponding to tree 708). Additionally, layer 748 includes a representation 751, which is optionally indicative of a path of movement of the viewpoint of user 704 while generating the information for the supplemental map. Representation 751 optionally has a spatial profile relative to the map that represents the movement of user 704 physically through the region indicated by layer 748, walking to building 706 and statue 710.

In some embodiments, the arrangement of elements included in layer 748 reflects the spatial arrangement of physical elements that user 704 interacted with while physically moving through the region of the map corresponding to layer 748. For example, computer system 101 detected the locations and/or relative placement of physical objects and stored information indicative of the locations and/or relative placement, and optionally uses the stored information to display a scaled and virtual model having a relative placement of virtual objects that reflects the relative placement of the physical analogues of the virtual objects. Object 750 and object 752, for example, are optionally separated by a distance and/or are located relative to each other in one or more directions. Similarly, statue 710 and tree 708 are optionally separated by a scaled-up version of the distance between objects 750 and 752, and/or in a same set of one or more directions.

In FIG. 7H, computer system 101 detects hand 406 perform an air pinch input while attention 734 is directed toward layer 748. As described with reference to method 800, the supplemental map is optionally presented immersively by computer system 101, such as in response to detecting the air pinch and attention 734 as shown in FIG. 7H. Additionally or alternatively, computer system 101 is able to detect an input requesting changing of a level of immersion as described with reference to method 800 (e.g., a turning of a dial and/or a button (e.g., a button that when pressed, displays a home user interface including application icons for applications stored at computer system 101), a voice command, movement of an air pinch in a direction, movement of a contact across a touch-sensitive or non-touch sensitive surface, and/or some combination thereof). In response to detecting the input, computer system 101 optionally initiates display of the supplemental map with a level of immersion in accordance with the input (e.g., the computer system initiates display of the supplemental map as shown in FIG. 7I). For example, the level of immersion changes from a first level to a second level in response to detecting a first rotation of a button, and/or changes from the first level to a third level in response to detecting a second rotation of the button, different from (e.g., greater than or less than) an amount of the first rotation.

In FIG. 7I, computer system 101 initiates display of a representation of the supplemental map using the information described with reference to FIGS. 7A-7E. For example, computer system 101 in FIG. 7I optionally displays an immersive spatial recording of the viewpoint of user 704 moving through a virtual reproduction of the physical environment of user 704 in FIG. 7B in response to detecting the input shown in FIG. 7H. In some embodiments, in response to the input, computer system 101 displays virtual content 758 at locations within three-dimensional environment 700 to emulate the experience of being physically placed in a physical equivalent of the virtual content. For example, computer system 101 optionally moves the viewpoint of the user (e.g., while the physical position and/or orientation of user 704 is maintained) through a virtual equivalent of the environment shown in FIG. 7B. The spatial recording, for example, optionally includes immersive video displayed while the viewpoint of user 704 moves from as shown in FIG. 7A to FIG. 7B. In FIG. 7I, computer system 101 displays a virtual building 764, corresponding to building 706 in FIG. 7B. In FIG. 7I, computer system 101 displays a representation 754 and/or information 757, which optionally identify virtual building 764 as a point of interest while user 704 traversed the physical environment. Representation 754 additionally or alternatively indicates that the two-dimensional screenshot captured in FIG. 7C is included in the supplemental map. In some embodiments, computer system 101 displays the two-dimensional screenshot in response to detecting input selecting representation 754.

In some embodiments, presenting the immersive maps experience includes presenting spatial audio that corresponds to audio detected while detecting information for the supplemental map. For example, as shown in the top-down view of three-dimensional environment 702, computer system 101 generates audio 760a and 760b (e.g., corresponding to audio 720a and 720b in FIG. 7B), optionally applying one or more filters and/or one or more time delays to simulate the spatial position of point sources located where audio 720a and audio 720b were positioned when the spatial recording was directed. Thus, computer system 101 collects spatial information while generating the supplemental map that is optionally used to recreate the sensation of point sources generating recorded audio with spatial fidelity while presenting the spatial recording. Although not shown via display 120, computer system 101 arranges a virtual object that represents additional or alternative physical objects such as object 766. In some embodiments, computer system 101 forgoes presenting of virtual content within three-dimensional environment 700, such as within an area 762 shown in FIG. 7I. Forgoing presenting of virtual content within area 762 optionally increases awareness of the surroundings of user 704.

In some embodiments, in addition to or in the alternative to presenting the immersive video, computer system 101 presents the supplemental map immersively and forgoes display of a recording of the movement. Instead, computer system 101 optionally updates the perspective of the user relative to the virtual reproduction of the physical environment of user 704 in accordance with movement of the viewpoint of user 704 (e.g., as described with reference to FIG. 7K).

From FIG. 7I to 7J, computer system 101 progresses the presenting of the spatial recording. For example, while the viewpoint of user 704 is maintained relative to the physical environment, computer system 101 updates the presented perspective of the virtual content 758 to virtually recreate the motion of user 704 moving from FIG. 7C to FIG. 7D. Accordingly, in FIG. 7J, computer system 101 displays a virtual statue 768 including virtual annotation 770 overlaying three-dimensional environment 700. Using spatial information captured by computer system 101 while generating the supplemental map, computer system 101 is able to display virtual annotation 770 overlaying virtual statue 768 with a spatial relationship analogous to and/or the same as when the virtual annotation is originally displayed in FIG. 7D and FIG. 7E. For example, virtual annotation 770 overlays virtual statue 768 around the head of the virtual statue 768, with an arrangement similar to or the same as where virtual annotation 740 is displayed relative to statue 710 in FIG. 7E. Thus, computer system 101 optionally presents the information associated with a supplemental map when presenting a virtual reproduction of the interactions of user 704 with the physical environment.

FIG. 7K illustrates display of virtual reproductions of a physical environment when presenting an immersive supplemental map. In some embodiments, computer system 101 uses the spatial and/or visual information collected while generating the spatial maps to explore portions of a recorded physical region that the user did not move to while generating a spatial recording. For example, from FIG. 7J to 7K, computer system 101 detects movement of the viewpoint of user 704 relative to the physical and/or virtual content included in three-dimensional environment 700, changing a position of user 704. In response to detecting the movement, computer system 101 optionally presents virtual reproductions of physical objects that user 704 did not necessarily move toward while generating the spatial recording, such as virtual trees 774a and 774b. For example, as shown in FIG. 7E, computer system 101 optionally terminates the spatial recording before moving toward the physical equivalents of virtual trees 774a and 774b.

By using the spatial information and/or image data recorded while the user physically moved within the physical region, computer system 101 allows exploration of a virtual reproduction of the physical region, providing a rich map interaction experience without necessarily requiring a user to direct a camera and/or viewpoint toward every portion of the physical region. Additionally, computer system 101 optionally uses data collected local to computer system 101 to reproduce the physical environment as shown in FIG. 7K, without necessarily relying upon image data obtained from external sources, thus making the immersive reproduction of the physical environment realistic to the memories and/or experiences of user 704. It is understood that in general, computer system 101 optionally collects and/or detects information such as audio, video paths of movement of a viewpoint, immersive video, spatial information, movement of portions of a body of user 704, and/or the like when generating the supplemental map. In some embodiments, when presenting the supplemental map via the maps user interface at a later time (e.g., while displaying the supplemental map with a level of immersion greater than a threshold level of immersion as described with reference to method 800), computer system 101 generates audio, image(s), video, animations, and/or some combination thereof using the detected information, thereby providing an immersive and realistic experience of interacting with an environment in a manner that mimics the physical environment of the user 704 while generating the supplemental map.

FIG. 7L illustrates a user interface for a maps application including a volumetric virtual object. For example, in FIG. 7L, computer system 101 displays a virtual object 778. Virtual object 778 optionally is a three-dimensional virtual object, which optionally includes three-dimensional buildings and/or optionally includes two or three-dimensional overlays indicating the presence of supplemental maps and/or related information corresponding to one or more geographic regions in a map. In some embodiments, virtual object 778 includes first virtual content that represents locations of physical objects and/or second virtual content such as virtual annotations that are added to the supplemental map. In some embodiments, the arrangement of the first virtual content included in virtual object 778 is displayed to mimic the physical arrangement of physical objects and/or physical locations of a viewpoint of user 704 while generating the second virtual content. For example, computer system 101 in FIG. 7L displays a first supplemental map overlaying a volumetric map of a city. The first supplemental map in FIG. 7L includes visual indications 784b and 784c, which optionally correspond to information such as images, videos, virtual annotations, audio recordings, and/or the like detected while generating the first supplemental map 786, and optionally are displayed at locations relative to the displayed map at which the user was physically located when the information was detected. Additionally, computer system 101 displays a shaded overlay indicating a boundary of the first supplemental map 786 at a region indicative of where the user 704 physically transited while generating the first supplemental map 786. In FIG. 7L, computer system 101 detects attention 734c directed toward the first supplemental map 786 concurrently while detecting an air pinch by hand 406 selecting the first supplemental map. In response to detecting the air pinch and attention 734c, computer system 101 optionally initiates display of the first supplemental map 786 and/or a spatial recording of the experience of user 704. As described above, it is understood that computer system 101 optionally displays the first supplemental map 786 with a level of immersion greater than a threshold level of immersion in response to and/or in accordance with input requesting an increase of a level of immersion, such as turning of a dial or button in a first direction and/or by a first amount, optionally while attention is directed toward the first supplemental map 786.

As an additional or alternative example, in FIG. 7L, computer system 101 displays a second supplemental map 782. Second supplemental map 782 is optionally displayed concurrently with the first supplemental map 786, optionally indicating relative to the map where user 704 physically moved within while generating second supplemental map 782. Additionally, second supplemental map 782 includes a visual indication 784a, which optionally corresponds to a spatial recording while moving as shown in FIG. 7A-7E and/or is displayed relative to the map at a location where the spatial recording was initiated when generating second supplemental map 782. Additionally, the second supplemental map includes virtual objects and/or representations similar to, or the same as those described with reference to FIGS. 7F-7K. FIG. 7L illustrates attention 734b, which is optionally an alternative to attention 734a and 734c, while hand 406 provides an air pinch gesture. As described above, the input optionally additionally or alternatively is an input requesting change of in level of immersion, such as turning of a button or dial and/or a voice command. Computer system 101 optionally displays the spatial recording and/or immersive supplemental map described with reference to 7F-7K in response to detecting such an air pinch gesture and attention 734b.

In some embodiments, computer system 101 facilitates movement of the virtual object 778 in response to detecting interaction with a grabber user interface element. For example, computer system 101 in FIG. 7L detects attention 734a concurrent with the air pinch gesture formed by hand 406 directed toward grabber 780. A grabber, for example, optionally is a user interface element that is selectable to move virtual content relative to three-dimensional environment 700 in accordance with input while the air pinch gesture is maintained. For example, from FIG. 7M to FIG. 7N, computer system 101 detects movement of hand 406, and in response, moves virtual object 778.

In FIG. 7M, computer system 101 moves virtual object 778 by distance(s) and/or in direction(s) similar to, or the same as movement of hand 406. In particular, computer system 101 pulls the virtual object 778 closer to user 704 from FIG. 7L to FIG. 7M in response to detecting a pulling of hand 406 toward user 704, thus enlarging content (from the viewpoint of the user) included in virtual object 778. Because the viewpoint of user 704 aligns with the first supplemental map 786 shown in FIG. 7L, initiates display of banner 788, which optionally includes selectable options that are selectable to initiate display of sharing and/or presenting of the supplemental map. Selectable option 790, for example, is optionally selectable to initiate display of a spatial recording and/or to display the supplemental map with a level of immersion greater than a threshold level of immersion, as described with reference to method 800. Selectable option 796 optionally is selectable to share the supplemental map with additional or alternative computer systems and/or electronic devices. Additionally or alternatively, computer system 101 displays banner 788 and/or the selectable options 790 and 796 in accordance with a determination that one or more criteria are satisfied, such as criterion satisfied when a viewport of computer system 101 includes first supplemental map 786 (and/or does not include any other supplemental maps), a criterion satisfied when the second supplemental map occupies a percentage of the viewport greater than threshold amount (e.g., 50%, 60%, 70%, 80%, 90%, or 95%), a criterion satisfied when computer system 101 detects attention and/or an air gesture provided concurrently while directed to first supplemental map 786, and/or a criterion satisfied when attention is directed toward a region within the first supplemental map for a period of time greater than a threshold period of time (e.g., 1, 3, 5, 7, 10, 15, 20, 25, or 30 seconds).

In FIG. 7M, computer system 101 displays visual indications representing information collected while generating a spatial recording and/or a supplemental map. For example, representation 707a optionally indicates a starting point of a route 703 through a geographic region. Representation 705 is optionally representative of an immersive and/or spatial video recorded by computer system 101 while generating the supplemental map. Representation 707 and/or representation 709 is optionally representative of a two-dimensional image generated by computer system 101 while generating the supplemental map.

In FIG. 7M, computer system 101 detects attention 792 directed to selectable option 796 while hand 406 performs an air pinch gesture. In response to detecting the air pinch gesture, computer system 101 initiates a process to share the supplemental map, such as with electronic device 500 as shown in FIG. 7N.

FIG. 7N illustrates an electronic device 500 displaying a user interface 711 via display generation component 504. Electronic device 500 optionally includes a planar display, and is not configured to present virtual content with a level of immersion greater than a threshold level of immersion. That said, electronic device 500 optionally presents a maps user interface corresponding to user interface 711 in response to (and/or after) receiving a supplemental map from computer system 101, which includes a supplemental map 713 (e.g., received from computer system 101) indicated by a dashed border. Supplemental map 713 optionally includes a representation 717 (e.g., corresponding to statue 710), a representation 719 (e.g., corresponding to tree 708), a representation 721 (e.g., corresponding to building 706), and/or representation 715 (e.g., corresponding to the transited path of user 704 moving as shown in FIGS. 7A-7E). In some embodiments, electronic device 500 performs one or more operations similar to or the same as described with reference to computer system 101 in response to detecting input interacting with the map and/or supplemental map 713. For example, electronic device 500 optionally detects touch input including contact of an object with a touchscreen corresponding to display generation component 504, a double-contact, a pinching of two contacts, a sliding of two contacts toward one another, a moving of one or more of the contacts in one or more directions, and/or the like. In response to detecting such touch input, electronic device 500 optionally initiates display of a recording of movement of user 704 through the physical environment, as described with reference to computer system 101, through the physical region that corresponds to supplemental map 713 using the information received from computer system 101. Thus, computer system 101 is able to share the supplemental map with devices and/or computer systems that are less-suited to display immersive virtual content, and the receiving devices and/or computer systems are able to display a corresponding representation of the supplemental map.

FIG. 8 is a flow diagram illustrating a method of generating and presenting supplemental maps in accordance with some embodiments. In some embodiments, a method 800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 800 are, optionally, combined and/or the order of some operations is, optionally, changed.

In some embodiments a computer system in communication with one or more input devices and a display generation component is configured to perform a method 800, such as computer system 101 as shown in FIG. 7A in communication with display generation component 120 and image sensors 120a-c. For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a circuitry and/or optical lenses (optionally integrated or external) for projecting a user interface or causing a user interface to be visible to one or more users. In some embodiments, the one or more input devices include an electronic device capable of receiving a user input (e.g., capturing a user input or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while a representation of a respective region of a physical environment included in a three-dimensional environment of the computer system is visible via the display generation component, such as a representation of a region of the physical environment included in three-dimensional environment 700, the computer system detects (802), via the one or more input devices, a first input, such as voice command 722 as shown in FIG. 7A. For example, the computer system detects an input while the physical environment is visible via a passive passthrough and/or via one or more images of the physical environment captured by cameras and displayed via the display generation component. In some embodiments, the respective region corresponds to what is visible via a viewport of the computer system. Additionally, the respective region is optionally included in a first region of the physical environment, the first region optionally further including one or more portions of the physical environment that are not visible via the display generation component. For example, the one or more portions are optionally outside the viewport of the computer system, and/or are out of a field of view of the user. In some embodiments, the first input includes a voice command, an air gesture (e.g., an air pinching of a plurality of fingers contacting one another, an air pointing of one or more fingers, and/or air closing of one or more fingers), selection of a physical button and/or selection of a virtual button, and/or movement of the user's viewpoint (e.g., the user's position and/or orientation relative to the three-dimensional environment). In some embodiments, the first input includes or is an enabling of an operating mode and/or configuration of the computer system. For example, the first input optionally is or includes a selection of a button that enables a spatial recording mode in which the computer system intelligently obtains information and/or data relating to its location relative to the physical environment.

In some embodiments, the computer system additionally or alternatively automatically performs the one or more operations associated with and/or performed in response to the first input and in accordance with a determination that one or more criteria are satisfied. For example, the one or more criteria include a criterion that is satisfied when the respective region corresponds to a significant location in the physical environment such as a major neighborhood, street, waterway, and/or geographic feature in the user's physical environment. Accordingly, when the one or more criteria including one such criterion is satisfied (e.g., optionally with or without detecting the first input), the computer system associates information with a supplemental map, as described further herein. In some embodiments, the computer system determines that the location is significant based upon data provided by other computer systems (e.g., servers, mobile devices, and/or wearable devices). In some embodiments, in accordance with a determination that the location satisfies one or more criteria associated with the data, the location is deemed significant, and if it does not satisfy the one or more criteria, it is deemed not significant. For example, the location is optionally significant when the data indicates that people often frequent that significant location, travel to the significant location, spend time moving within and/or around that significant location, and/or that vehicles such as cars, buses, and/or trains deliver passengers to that location. Thus, the one or more criteria optionally include a criterion satisfied when a volume of users that have visited the location is greater than a threshold volume, include a criterion satisfied when users spend time around or at the location greater than a threshold amount of time (e.g., 0.05, 0.1, 0.5, 1, 5, 10, 15, 20, 30, or 60 minutes), and/or include a criterion satisfied when transportation data indicates a number of users greater than a threshold number of users frequently move through the location. Additionally, the one or more criteria optionally include a criterion satisfied when the location is included in a listing of significant locations stored at the computer system and/or obtained from another computer system. In some embodiments, the data indicates that the significant location includes a notable landmark, based upon mapping data provided by another device. Additionally or alternatively, the computer system optionally recognizes the respective region of a significant location in accordance with a determination that one or more supplemental maps that the computer system is aware of (e.g., via a maps application) include the significant location in the one or more supplemental maps. For example, the location is deemed significant when one or more city guide supplemental maps, one or more architectural supplemental maps, and/or one or more food and beverage-centric supplemental maps include the significant location as a point of interest for a user of the computer system. In some embodiments, the one or more criteria include a criterion that is satisfied when the computer system and/or the user of the computer system has remained within a region of the physical environment for a period of time greater than a threshold period of time. For example, the computer system optionally determines a physical region of the environment corresponding to a significant location (e.g., a region around a landmark) and/or arbitrarily determines a region (e.g., radius) surrounding the computer system. In accordance with a determination that the user's location remains within the physical region for a period of time greater than a threshold period of time (e.g., 5, 10, 15, 30, 45, 60, 90, 120, 180, 240, 300, or 6000 seconds) the previously described criterion is satisfied.

In some embodiments, in response to detecting the first input (804), in accordance with a determination that the respective region is a first region, such as physical region corresponding to the region represented by supplemental map 786 as shown in FIG. 7L, the computer system associates (806) first information that is associated with the first region with a first supplemental map, such as a path of movement represented by representation 751 as shown in FIG. 7G, wherein the first input does not indicate (and/or define) the first information associated with the first region. For example, the computer system automatically performs the operations described with reference to the “respective region” herein without detecting additional one or more inputs. For example, the computer system optionally determines that the respective region and/or the region of the physical environment surrounding the user's viewpoint is a first region of the first physical environment. Because the respective region is determined to be the first region (e.g., by the computer system, and/or another computer system such as a server in communication with the computer system), the computer system optionally associates the first information with the first supplemental map. In some embodiments, the first information includes voice input from the user of the computer system, one or more images (e.g., photographs and/or video) detected via the computer system, location data (e.g., GPS data), spatial data capturing objects and/or a topography of the user's environment, and/or ambient audio. In some embodiments, the computer system establishes a geotagged relationship between the first region of the physical environment and the first information when associating the first information with the first supplemental map. In some embodiments, the first region of the physical environment corresponds to a portion of a supplemental map (described further herein). In some embodiments, the computer system determines a geotagging between a respective first portion of the first supplemental map and the first region of the physical environment. In some embodiments, as described further herein, the computer system can present the first supplemental map including the first information.

In some embodiments, the first supplemental map is an additional map for a first geographic area that includes details about regions within the first geographic area, such as businesses, parks, stages, restaurants and/or snack stands. In some embodiments, the first supplemental map does not include information for a second geographic area that is included in the primary map. In some embodiments, the first supplemental map is interactive. In some embodiments, the information associated with the supplemental map (which is optionally not included in the primary map) is displayed concurrently with and/or overlaid upon the primary map of the first geographic area, which optionally includes information about the locations from the primary map. In some embodiments, the information from the supplemental map is displayed with visual indications to visually differentiate the information from the supplemental map from the information from the primary map. For instance, the information from the supplemental map is optionally displayed with a different color than the information from the primary map, or is highlighted while the information from the primary map is not highlighted or is highlighted including a different level of highlighting. In some embodiments, the supplemental map includes information about the one or more locations that is in addition to (e.g., different or supplemental to) the information about the one or more locations included in the primary map. In some embodiments, the primary map does not include information about the one or more locations, and therefore the only information displayed by the computer system about the one or more locations is information from the supplemental map. In some embodiments, the information from the supplemental map replaces the information from the primary map for one or more of the one or more locations.

In some embodiments, the computer system intelligently and/or automatically (e.g., without user input for doing so) determines respective information to associate with the first supplemental map. For example, the first input optionally includes a voice command to generically “capture a memory,” and/or optionally includes selection of a physical or virtual button that generically requests that information be captured, without expressly defining a type of information (e.g., an image, planar video, immersive video, spatial data and/or text) that will be captured. The computer system optionally detects a user and/or device context relative to their three-dimensional environment, and optionally records information that relates to the respective region (e.g., the first information) that is visible. For example, the computer system records video in response to the first input, records video as the user moves throughout the first region of the physical environment, and/or records video that the computer system recently recorded and held in temporary storage as the user moves about the first region. In some embodiments, the computer system records additional or alternative data. For example, the computer system optionally retrieves data associated with the location, for instance user reviews related to the location, from another computing system such as a server. Additionally or alternatively, the computer system detects that the user's viewpoint is oriented toward a significant location (e.g., the viewport of the user presents a notable landmark), and optionally stores video of the user moving toward and around the significant location.

In some embodiments, the first input includes movement of the user's viewpoint throughout the first region, when the first region corresponds to a building or area that is deemed significant. In some embodiments, the computer system intelligently selects a type and/or format of information and/or data to be recorded based upon user context. For example, in response to the first input and in accordance with the determination that the respective region is the first region, the computer system optionally determines the user's context is a first or a second context. As a further example, in accordance with a determination that the user's viewpoint is or has recently moved greater than a threshold amount (e.g., 0.01, 0.05, 0.1, 0.25, 0.5, 0.75, 1, 1.5, 3, or 5 m), the computer system optionally determines that the user context is a first context (e.g., is moving) and optionally captures planar video and/or location data tracking the user's movement. In accordance with a determination that the user's viewpoint is or has not recently moved greater than the threshold amount, the user context is optionally determined to be a second context, and the computer system optionally obtains a static image based upon a target of the user's gaze and/or obtains spatial information mapping the area surrounding the user's viewpoint. In some embodiments, the computer system forgoes obtaining of information corresponding to a context that is different from the user's determined context. For example, the computer system optionally records location data, but does not obtain a still image of what is visible via the display generation component when the user is moving. As a further example, the computer system optionally determines that the user is traversing a road, gazing toward a landmark, observing a piece of art, and/or moving through the store corresponding to different contexts. In response to the determination of context, the computer system optionally captures the first information including a first type or format of data (e.g., spatial data, video data, image data, text, and/or a first format of such data) when the user context is the first context. Alternatively, the computer system optionally captures the first information including a second type or format of the data (e.g., spatial data instead of video data, image data instead of text, video data instead of spatial data, and/or other combinations) that is different from the first type of format of the data in accordance with a determination that the user's context is a second context, different from the first context.

In some embodiments, the first supplemental map is associated with a primary map. For example, the primary map includes information providing a map of a region, such as a map of a city, state, country, continent, or another large-scale geographic region. The primary map optionally is presented via the display generation component and via a maps user interface stored in memory of the computer system. In some embodiments, the primary map includes or is displayed using information used to display a view of the streets, landmarks, geographic features, topography, public transportation lines, and the like included in the region of the earth defined by the primary map. In some embodiments, the first supplemental map includes information (e.g., the first information) that can be presented overlaying portions of the primary map. For example, the supplemental map includes information mapping between regions and points of the user's interest that are visually distinguished and overlay a representation of the primary map. For example, the supplemental map includes and/or is used to display (by the computer system) outlines, visual indications such as icons, simulated glowing effects, virtual representations of physical objects, media, and/or text that overlays the displayed primary map. As a further example, the computer system optionally displays a representation (e.g., thumbnail), of an image captured by the computer system overlaying the primary map in the maps user interface, at a geolocation corresponding to where the computer system captured that image (e.g., corresponding to the first region of the physical environment). Additionally or alternatively, the visual indication is an icon visually indicating that additional or alternative content (e.g., immersive video, a voice recording, planar video, text and/or handwritten annotations) was captured at the geolocation of the visual indication.

In some embodiments, in response to detecting the first input (804), in accordance with a determination that the respective region is a second region, different from the first region, such as a physical region corresponding to the region represented by second supplemental map 782, the computer system associates (808) second information that is associated with the second region with the first supplemental map, such as audio 720a-c as shown in FIG. 7A, wherein the first input does not indicate (and/or define) the second information associated with the second region, and wherein the second information is different from the first information. For example, because the respective region is determined to be the second region (e.g., by the computer system, and/or another computer system such as a server in communication with the computer system), the computer system optionally associates the second information with the first supplemental map and optionally forgoes associating the first information with the first supplemental map. In some embodiments, the second information includes voice input from the user of the computer system, one or more images (e.g., photographs and/or video) detected via the computer system, spatial data capturing objects and/or a topography of the user's environment at the second region of the physical environment, and/or ambient audio captured at the second region of the physical environment. Similarly to as described with reference to the first information, the computer system optionally associates the second information with the first supplemental map when the first input does not indicate specific information, a specific type of information, and/or a specific format of information. The second information is optionally analogous to and/or has one or more of the characteristics of the first information.

In some embodiments, the computer system captures a same set of information (e.g., spatial information mapping the user's physical environment) independent of the user's viewpoint using sensors that capture the user's surroundings. For example, in accordance with a determination that the user's viewpoint is a first or second orientation relative to a same region of the physical environment, the computer system optionally captures a same set of spatial data mapping objects and/or the features of the user's physical environment by using sensors that collect spatial data and/or images extending three-hundred and sixty degrees around the user's viewpoint. As an example, the computer system optionally captures a same set of spatial data irrespective of whether they face forward toward a storefront, or with their back toward the storefront. Associating first or second information with the first supplemental map in accordance with a determination that the respective region is a first or second region improves the likelihood that relevant information is captured in the first supplemental map, thus reducing user input required by the user to specify information that relates to a region that the user occupies and/or to which the user's attention is directed, thereby reducing processing and computation required to perform operations in accordance with the user input.

In some embodiments, after associating information with the first supplemental map (e.g., the first information or the second information) in response to detecting the first input, the computer system detects, via the one or more input devices, a second input, different from the first input, such as selection of layer 748 as shown in FIG. 7H and/or an input requesting a change in level of immersion, such as a rotating of button 724 (shown in FIG. 7B) while attention is directed to layer 748 as shown in FIG. 7H. For example, the second input is optionally a voice command, a selection of a physical or virtual button, a selection of a graphic representative of the first supplemental map, a selection of a graphic representative of a primary map that includes the first supplemental map, and/or is optionally an input requesting display of a user interface of a mapping application, described further at least with reference to method 800.

In some embodiments, in response to detecting the second input (e.g., automatically and/or without detecting additional intervening inputs), the computer system displays a first representation of the first supplemental map, such as layer 748 as shown in FIG. 7Y, wherein the first representation is displayed with a level of immersion that is greater than a threshold level of immersion relative to the three-dimensional environment, such as the immersive display of three-dimensional environment 700 including virtual statue 768 and/or virtual annotation 770 as shown in FIG. 7J. For example, the first representation of the first supplemental map is displayed overlaying a representation of the primary map associated with the first supplemental map. The first representation optionally includes representations of buildings, roads, paths, markers indicating that user moved to a location (e.g., pointing to a particular location, highlighting a traversed route, and/or some combination thereof) included in the first supplemental map, and/or landmarks. Such representations optionally, and respectively are displayed using respective information that is previously associated with the first supplemental map, such as the first and/or the second information. As an example, displaying the first representation optionally includes a visual distinguishing (e.g., a fill pattern, a border, a changing in scale, a halo lighting effect, a displaying of a marker pointing toward) a representation of a building that the user of the computer system has visited, using metadata, JavaScript object notation (JSON) data, markup data, and/or the like. Additionally or alternatively, the computer system optionally displays a highlighted path of one or more instances of the user moving throughout a region of the primary map using metadata and/or data associated with the first supplemental map. In some embodiments, the computer system displays representations of media captured by the computer system in response to the first input, such as image(s) including a thumbnail of a video sequence that was associated with the first supplemental map, a photograph, an indication of a voice recording (e.g., an icon, graphic, and/or another visual distinguishing of a portion of the first supplemental map), and/or text stored by the computer system.

In some embodiments, the computer system displays the first representation with a level of visual prominence relative to the three-dimensional environment. In some embodiments a representation of a physical environment (e.g., displayed via virtual passthrough or optical passthrough) can be partially or fully obscured by a virtual environment and/or content, such as virtual content included in displaying a view of a supplemental map and/or content included in the supplemental map. In some embodiments, the amount of virtual content that is displayed (e.g., the amount of physical environment that is not displayed) is based on an immersion level for the virtual content (e.g., with respect to the representation of the physical environment). For example, increasing the immersion level optionally causes more of the virtual content to be displayed, replacing and/or obscuring more of the physical environment, and reducing the immersion level optionally causes less of the virtual content to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system obscures background content (e.g., content other than the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion).

In some embodiments, the first representation is displayed occupying and/or consuming one or regions of the user's three-dimensional environment at the level of visual prominence. For example, the first representation of the first supplemental map is optionally centered in the user's field of view, consuming some or all of viewport of the computer system. In some embodiments, in response to an input requesting changing of the level of visual prominence (e.g., a voice command, selection(s) of virtual or physical button(s), and/or a turning of an electromechanical crown) the computer system increases or decreases the level of visual prominence of the first supplemental map, the primary map associated with the first supplemental map, and/or a maps user interface in accordance with the input (e.g., by a magnitude, and/or in a direction of the first input (e.g., force of a contact, amount of rotation of the electromechanical crown, and/or a number and/or duration of contact of the virtual or physical button(s)). For example, the computer system optionally displays the first representation of the supplemental map overlaying the representation of the primary map consuming a first region of the three-dimensional environment, and in response to a turning of the crown in a first direction and by a first amount, optionally displays the first representation and/or the representation of the primary map consuming a second region of the three-dimensional environment (e.g., larger than or smaller than the first region). Additionally, in response to detecting a turning of the crown in a second direction opposing the first, and by a second amount that is different from the first amount, the computer system optionally displays the first representation and/or the representation of the primary map consuming a third region (e.g., larger than or smaller than the first and/or the second regions). Additionally or alternatively, the computer system optionally concurrently scales the first representation of the first supplemental map and/or the primary map in accordance with the input changing the level of immersion (e.g., proportionally, inversely, or otherwise based upon the change in level of immersion).

In some embodiments, displaying the first representation of the first supplemental map, such as layer 748 as shown in FIG. 7Y, wherein the first representation is displayed with the level of immersion that is greater than the threshold level of immersion relative to the three-dimensional environment includes, in accordance with the determination that the respective region is the first region, presenting the first information, such as the virtual annotation 770 as shown in FIG. 7J. For example, the computer system optionally displays an icon pointing to the first region and/or otherwise visually distinguishes the first region, and/or display of an icon pointing to and/or optionally forgoes visually distinguishing the second region while maintaining display of a representation of primary map. In some embodiments, presenting the information includes displaying an image captured while the user was located within the first region. In some embodiments, presenting the information includes generating audio corresponding to audio that was captured and associated with the first supplemental map in response to and/or after the first input is detected (e.g., audio detected by the computer system before, in response to, and/or after the first input is detected), and captured while the user was located within the first region. In some embodiments, presenting the information includes displaying a plurality of images (e.g., in a photo album-type user interface, and/or displaying video) captured while the user was located within the first region. In some embodiments, presenting the first information includes displaying immersive video captured while the user moved through the first region. In some embodiments, presenting the first information additionally or alternatively includes displaying an animation of a representation of the user's position moving through the first region based upon their movement through the first region (e.g., before, in response to, after, and/or while the first input is ongoing). In some embodiments, the first information is presented while the computer system maintains display of the first representation of the first supplemental map, or is presented while the computer system forgoes display of the first representation of the first supplemental map.

In some embodiments, displaying the first representation of the first supplemental map, such as layer 748 as shown in FIG. 7Y, wherein the first representation is displayed with the level of immersion that is greater than the threshold level of immersion relative to the three-dimensional environment includes, in accordance with the determination that the respective region is the second region, different from the first region, presenting the second information, different from the first information, such as a spatial recording corresponding to visual indication 748c as shown in FIG. 7M. In some embodiments, presenting the second information has one or more characteristics similar to or the same as described with reference to presenting the second information, but relative to the second information captured while the user was moving within and/or through the second region and/or in response to the first input. For example, the computer system optionally displays immersive video, optionally plays audio detected by the computer system, optionally displays one or more images, and/or displays a representation of the user moving through the first supplemental map based upon the second information captured while the user corresponded to the second region of the three-dimensional environment.

In some embodiments, in response to a request to cease display of the first supplemental map, the computer system forgoes display of the first representation of the first supplemental map.

In some embodiments, the computer system displays, via the display generation component, a maps user interface including a visual indication corresponding to the first supplemental map, wherein the second input includes selection of the visual indication, such as display of layer 748 and selection via hand 406 of layer 748 as shown in FIG. 7H. For example, the second input optionally includes a selection input directed to a visual indication displayed by the computer system, and/or optionally included in a maps user interface. In some embodiments, a selection input includes a selection of a virtual or physical button, a pressing of an electromechanical crown button, a contacting of a surface (e.g., a non-touch sensitive surfaced monitored by the computer system and/or a touch-sensitive surface in communication with the computer system), a voice command, and/or an air gesture (e.g., an air pointing of a finger, an air pinching of a plurality of fingers of a user's hand, and/or an air closing of a plurality of fingers) optionally while the user's attention (e.g., gaze) is directed to the visual indication and/or a cursor is directed to the visual indication. In some embodiments, the visual indication is an icon, graphic, video, text, and/or three-dimensional virtual object that corresponds to the first supplemental map. Presenting information in response to the second input including the selection input reduces power consumption required to display the information when the user is not yet interested in consuming the information.

In some embodiments, the computer system displays, via the display generation component, a maps user interface including a visual indication corresponding to the respective region, wherein the second input is directed toward the visual indication corresponding to the respective region, such as selection via hand 406 while attention 734c is directed to first supplemental map 786 as shown in FIG. 7L. For example, as described previously with reference to the first and/or second information, the computer system optionally visually distinguishes a portion of a primary map corresponding to the respective region. In such an example, the computer system optionally presents the first and/or second information in response to selection input-described further herein-directed to the representation of the respective region. In some embodiments, the visual indication is an icon, graphic, video, text, and/or three-dimensional virtual object that corresponds to the first supplemental map. For example, the visual indication optionally is a picture captured by the computer system and a text label (e.g., “Prague”) corresponding to information captured while the user moved about the respective region, and/or a highlighting of a neighborhood on a primary map.

In some embodiments, the computer system displays a view of a map which includes one or more visual indications of supplemental maps that are available for display. Optionally, the visual indications are buttons, icons, pictures, media, and/or a combination of such user interface elements. In some embodiments, the visual indications are selectable to display corresponding supplemental map content, such as the icon, graphic, video, and/or text described above. In some embodiments, in response to detecting selection input directed toward a selectable option, the computer system displays virtual content corresponding to the target of the selection input. For example, the computer system optionally displays text, replays a voice note, and/or displays environmental content and/or a stereo image at a level of immersion greater than the threshold level of immersion described with reference to method 800. In some embodiments, the location of the visual indications is based upon the supplemental map that information relates to. For example, the location can be a first location within a first supplemental map area when information is captured while moving throughout the first supplemental map area, or can be a second, different location within a second supplemental map area when the information is captured while moving throughout the second supplemental map area. Presenting information in response to the second input directed to the visual indication reduces power consumption required to display the information when the user is not yet interested in consuming the information, and reduces the likelihood that the user erroneously requests display of the first supplemental map by identifying the region associated with the first supplemental map.

In some embodiments, the computer system displays, via the display generation component, a maps user interface including a visual indication corresponding to respective information associated with the first supplemental map. For example, the maps user interface optionally has one or more characteristics of the maps user interface(s) described herein.

In some embodiments, in accordance with the determination that the respective region is the first region, the visual indication is a first visual indication corresponding to the first information, such as visual indication 748b as shown in FIG. 7L. For example, the computer system optionally displays the first visual indication corresponding to the first region (e.g., an icon, text, media, a three-dimensional object) overlaying and/or included in the maps user interface. As described previously, the first visual indication is optionally different from a second visual indication corresponding to the second region when the first input was detected and the respective region was the first region. Alternatively, the computer system optionally displays the second visual indication instead of the first visual indication (e.g., forgoes display of the first visual indication) overlaying and/or included in the maps user interface when the respective region was the second region. In some embodiments, the form of the visual indication indicates a type of corresponding content. For example, the computer system optionally displays a screenshot preview which when selected, optionally causes the computer system to display a stereo image. Additionally or alternatively, the screenshot can correspond to immersive virtual content such as an environmental preview that when selected, causes the computer system to display a virtual environment corresponding to an immersive experience using spatial data included in the first information.

In some embodiments, in accordance with the determination that the respective region is the second region, the visual indication is a second visual indication corresponding to the second information, and in some embodiments, the second input is directed toward the visual indication corresponding to the respective region such as visual indication 748a as shown in FIG. 7L. For example, the second visual indication optionally has one or more characteristics similar to or the same as the first visual indication. For example, the second input is similar to or the same as the second input(s) described herein. Displaying a visual indication corresponding to respective information included in the first supplemental map reduces user input required to separately request display and/or required to separately inspect the maps user interface and related information, thereby reducing power consumption of the computer system.

In some embodiments, the computer system detects, via the one or more input devices, spatial audio, such as audio 720a-c as shown in FIG. 7A, wherein associating the first supplemental map with the first information includes including the spatial audio in information used to generate the first supplemental map, and associating the first supplemental map with the second information includes including the spatial audio in information used to generate the first supplemental map, such as associating audio 720a-c from as shown in FIG. 7A with first supplemental map 786 and/or with second supplemental map 782, respectively shown in FIG. 7L. In some embodiments, the computer system detects, stores, associates, and/or includes audio in the first supplemental map. In some embodiments, the audio is detected and/or stored by the computer system that is audible within the user's environment in response to the first input and/or in accordance with a determination that one or more criteria are satisfied (e.g., without detecting a respective input). For example, the first and/or second information described with reference to method 800 optionally corresponds to audio present in the user's physical environment that is detected by the computer system, and associated with the first supplemental map when the user of the computer system moves around a significant location. In some embodiments, the computer system presents the audio when the user requests presentation of the first supplemental map (e.g., when the user selects an affordance corresponding to a supplemental map of a city, of a building, and/or of a neighborhood). In some embodiments, the computer system presents the audio as though the user were physically placed in the first or the second region. For example, the audio is optionally detected by one or more microphones and/or generated by audio output device(s) (e.g., speakers, cells, headphones, and/or earbuds) as though respective sounds included in the audio were made by physical objects and physical phenomena in the user's three-dimensional environment (e.g., in the first region and/or the second region of the user's physical environment). As an example, the audio optionally is ambient audio including the sounds of voices, vehicles, environmental effects like wind, and the like. In some embodiments, in response to detecting a change in the user's viewpoint while presenting the audio, the computer system changes characteristic(s) of the audio to simulate a perceived change in a physical audio source based upon the user's changed viewpoint. For example, the computer system optionally presents first spatial audio corresponding to a first location in the three-dimensional environment (e.g., corresponding to a physical relationship between a physical audio source that generated the first spatial audio, like a horn blaring), and having a first spatial relationship with the user's viewpoint. In response to detecting a change to a second, different viewpoint that changes the spatial relationship between the user viewpoint and the first location, the computer system optionally changes the first spatial audio (e.g., in time delay and/or amplitude) such that the first spatial audio continues to correspond to the first location (now a different location and/or orientation relative to the viewpoint of the user).

In some embodiments, the location of detected spatial audio and the spatial relationship of the location to a viewpoint of the user is detected, determined, and/or stored. In some embodiments, when a user displays a supplemental maps experience at a later time, the computer system can use information including a time that the spatial audio was detected and the location of the spatial audio to simulate the experience that the sound is generated at a time and at a location relative to a virtual recreation of the experience using the supplemental map (e.g., having the same spatial relationship relative to the virtual recreation of the experience (e.g., the displayed virtual content of the supplemental map) as it had when the audio was first detected/recorded). For example, spatial audio when presenting a supplemental map experience, the audio is optionally generated to correspond to a first location within the supplemental maps experience. When generating the audio while displaying the immersive virtual content corresponding to a supplemental map, the audio can be generated corresponding to the first location within supplemental map experience. Accordingly, when a spatial relationship between the viewpoint of the user and the first location is a first spatial relationship when the audio is detected, the computer system optionally generates the spatial audio when displaying the supplemental map experience having the first spatial relationship relative to the viewpoint of the user. Because the spatial audio is optionally anchored to the first location relative to a virtual recreation of the physical environment, in response to detecting movement of the viewpoint of the user relative to the virtual recreation of the physical environment, the computer system optionally updates the perceived spatial relationship in accordance with movement of the viewpoint.

In some embodiments, the audio is proactively detected and/or at least temporarily stored in memory such that when the one or more criteria are satisfied and/or the first input is detected, the computer system associates audio that precedes the satisfaction of the one or more criteria and/or precedes detection of the first input with the first supplemental map. Detecting and associating spatial audio with the first supplemental map provides an audible indication of the user's position and/or orientation relative to their previous physical environment and/or lends realism to presentation of the first supplemental map, thus reducing the likelihood the user erroneously traverses a representation of the first supplemental map, thereby reducing processing required to perform operations based upon the erroneous travel.

In some embodiments, the computer system displays, via the display generation component, a representation of the first supplemental map wherein the representation is presented based on a viewpoint of a user of the computer system that is a first viewpoint, such as displayed in three-dimensional environment 700 as shown in FIG. 7I. For example, the computer system optionally displays a map corresponding to a neighborhood, city, and/or building and/or optionally displays immersive video that at least partially consumes a viewport of the computer system as though the user is situated at a first position relative to the immersive video and/or has a first orientation relative to the immersive video.

In some embodiments, while displaying the representation of the first supplemental map and while the viewpoint of the user is the first viewpoint, the computer system generates respective first spatial audio corresponding to the spatial audio that is associated with the first supplemental map in response to detecting the first input such as spatial audio 760a-b as shown in FIG. 7I. For example, the respective first spatial audio (and/or the respective second spatial audio described below) optionally have one or more characteristics of the spatial audio described herein.

In some embodiments, the computer system detects, via the one or more input devices, a change in the viewpoint of the user to a second viewpoint different from the first viewpoint, such as a change in viewpoint of user 704 from as shown in FIG. 7I to as shown in FIG. 7K. For example, the computer system optionally detects a moving of the user's body relative to the three-dimensional environment, and/or optionally detects one or more inputs requesting a simulated movement of the viewpoint (e.g., input directed to a trackpad changing the user's virtual position relative to the representation of the first supplemental map, a voice command, and/or movement directed to a joystick).

In some embodiments, in response to detecting the change in viewpoint to the second viewpoint, the computer system presents, via the display generation component, the representation of the first supplemental map relative to the second viewpoint, such as three-dimensional environment 700 as shown in FIG. 7K. For example, the computer system optionally updates the displayed immersive video corresponding to previously not displayed representation(s) of the user's physical environment included in the first and/or second region described with reference to method 800 (e.g., in response to detecting a change in position and/or orientation included in the viewpoint of the user). The updated immersive video, for example, optionally includes representations of objects and/or other portions of the physical environment (e.g., clouds, roads, a sky, and/or a ground) that would be visible if the user's viewpoint changed in the corresponding region of the physical environment by an amount and/or in a direction similar to, or the same as, the detected change.

In some embodiments, in response to detecting the change in viewpoint to the second viewpoint, the computer system generates respective second spatial audio, different from the respective first spatial audio, corresponding to the spatial audio that is associated with the first supplemental map in response to detecting the first input such as the presentation of spatial audio 760a-b as shown in FIG. 7K. As described further herein, the computer system optionally presents audio that was associated with the first supplemental map as though the user physically was moving and/or turning relative to the three-dimensional environment (e.g., in response to detecting a change in position and/or orientation included in the viewpoint of the user). As an example, the computer system optionally records audio of a car alarm within the user's physical environment, and later presents audio of the car alarm while concurrently presenting the representation of the first supplemental map. In some embodiments, the audio is generated emanating from a virtual sound source that is placed within the user's three-dimensional environment at a position corresponding to the physical position of the car alarm. In response to detecting changes in the user's viewpoint, the computer system optionally changes characteristics of the car alarm audio (e.g., increasing a volume, decreasing the volume, changing a spatial relationship between the user's viewpoint and the virtual audio source) to mimic the perception of the user physically moving relative to the car alarm. Detecting and associating spatial audio with the first supplemental map provides an audible indication of the user's position and/or orientation relative to their previous physical environment and/or lends realism to presentation of the first supplemental map, thus reducing the likelihood the user erroneously traverses a representation of the first supplemental map, thereby reducing processing required to perform operations based upon the erroneous travel.

In some embodiments, in accordance with a determination that a viewpoint of a user of the computer system is a first viewpoint when the first input is detected, the first information is respective first information, such as images and/or video captured as shown while a viewpoint of user 704 is as shown in FIG. 7B. For example, the computer system optionally associates representations of the user's physical environment including an image, video, virtual objects, and/or representations of physical objects (e.g., spatial models of physical objects) with the first supplemental map based upon the user's position and/or orientation relative to the three-dimensional environment. In some embodiments, the particular representation(s) associated with the first supplemental map are based upon the user's viewpoint relative to the three-dimensional environment when the first input is detected. For example, the computer system optionally detects and associates (e.g., stores, links, and/or otherwise establishes metadata linking between) one or more images and the first supplemental map. The first one or more images optionally correspond to what is displayed via the computer system viewport when the first input is detected. Accordingly, the computer system optionally associates first one or more images with the first supplemental map in accordance with a determination that the viewport is presenting (e.g., displaying and/or allowing visibility of) a first portion of the first region (or the second region) of the physical environment when the first input is detected. It is understood that the respective information optionally is based upon the user's viewpoint, and optionally independent and/or different from what is visible via the viewport. For example, the computer system optionally captures image(s) and/or spatial data of the users surrounding that are associated with the first supplemental map, optionally in addition to what is presented via the viewport. In some embodiments, the respective information includes a representation and/or annotation corresponding to a physical object that corresponds to the first viewpoint, such as a statue, a notable building, and/or a popular business that is visible to the user at the first viewpoint (and/or not visible at the second viewpoint, described below).

In some embodiments, in accordance with a determination that the viewpoint of the user of the computer system is a second viewpoint, different from the first viewpoint, when the first input is detected, the first information is respective second information, different from the respective first information, such as images and/or video captured as shown while a viewpoint of user 704 is as shown in FIG. 7D. For example, the computer system optionally associates second one or more images with the first supplemental map in accordance with a determination that the viewport is presenting (e.g., displaying and/or allowing visibility of) a second portion of the first region (or the second region) of the physical environment when the first input is detected. In some embodiments, the respective first and/or second information includes location data such as global positioning data, orientation data indicating the orientation of the viewpoint, and/or audio (e.g., including information to determine a location of the audio relative to the viewpoint of the user). Associating the first supplemental map with respective information based upon the user's viewpoint when the first input is detected reduces the likelihood that the first supplemental map is linked with information that the user is not interested in, thus reducing user input required to remove the association between the first supplemental map and the respective information and thereby reducing processing required to perform operations in response to the user input.

In some embodiments, the computer system (e.g., before, in response to, and/or after detecting the first input) detects, via one or more cameras in communication with the computer system, one or more images, wherein the one or more images correspond to a viewpoint of a user of the computer system relative to the three-dimensional environment such as one or more images captured by image sensors 120a-c as shown in FIG. 7A. For example, the one or more cameras are included in a housing and/or otherwise in wired or wireless communication with the computer system. In some embodiments, the one or more cameras detect stereoscopic images of the three-dimensional environment. In some embodiments, user's viewpoint relative to the three-dimensional environment is based upon the viewport of the computer system, is based upon the field-of-view of the one or more cameras, and/or is based upon a virtual aggregation of fields-of-view of a plurality of such cameras.

In some embodiments, the first information includes respective one or more images of the first region of the physical environment that are included in the one or more images, such as image(s) of three-dimensional environment 700 as shown in FIG. 7A. For example, the respective one or more images are images of the three-dimensional environment detected by cameras oriented outward relative to a housing of the computer system and/or away from the user's body. In some embodiments, the first information includes such (e.g., stereoscopic images and/or two-dimensional image (e.g., still images and/or video)). Thus, the computer system optionally detects images of the user's three-dimensional environment and associates the detected images with the first supplemental map. In some embodiments, the computer system detects a plurality of images and aggregates those images to form three-dimensional video and/or stereoscopic video. For example, the computer system optionally stores and/or associates video depicting the user's viewport while moving about the first region and/or video beyond the viewport, surrounding the user while located within the first region. In some embodiments, the computer system presents such images when presenting the first supplemental map. For example, the computer system optionally displays the one or more images captured by the one or more cameras as planar images and/or stereoscopic images. In some embodiments, in response to detecting changes in the user's viewpoint while viewing the stereoscopic image(s), the computer system changes the user's viewpoint relative to the three-dimensional environment that is simulated by the stereoscopic images, similar to as though the user were moving through the three-dimensional environment.

In some embodiments, the second information includes respective one or more images of the second region of the physical environment that are included in the one or more images, such as images of three-dimensional environment 700 as shown in FIG. 7D. For example, the respective one or more images of the second region of the physical environment have one or more characteristics similar to or the same as those described with reference to the respective one or more images of the first region of the physical environment. Thus, the computer system optionally captures and/or optionally presents images detected by one or more cameras depicting the user's physical environment while moving through a respective region. Including one or more images in respective information associated with the first supplemental map allows the user to view representations of the user's physical environment that are otherwise inaccessible and/or not unique to the user's experience.

In some embodiments, the first input includes a request to include a virtual annotation in the three-dimensional environment, such as input provided by hand 406 as shown in FIG. 7D to FIG. 7E. For example, the request optionally includes a voice command, an air gesture, a contact with a surface (e.g., a trackpad and/or non-touch sensitive surface), a selection of a physical and/or virtual button, dwelling of a gaze of the user, and/or a combination of one or more such inputs and/or requests. As an example, the computer system optionally detects a voice command requesting “storing of a memory” and/or an air pinch gesture directed toward a virtual button. In some embodiments, the first input is a generic input that initiates capture of a virtual annotation, and the computer system intelligently determines a suitable data format of the virtual annotation. In some embodiments, the computer system performs one or more operations that are described below in response to detecting the first input, in response to a second input that is different from the first input and/or specifies a data type and/or format to capture. For example, the second input optionally is a request to capture an image, a voice recording, initiate text entry, and/or a combination of one or more of such requests. In some embodiments, the computer system detects input corresponding to simulated marking directed toward the three-dimensional environment. In response to detecting the input, the computer system optionally displays a representation of the simulated marking, such as a simulated ink and/or spray paint overlaying the three-dimensional environment. The input requesting the marking, for example, optionally includes one or more of detecting attention of the user targeting a portion of the three-dimensional environment, movement of the attention, one or more air gestures such as pinching of fingers, selection of a button, and/or some combination thereof. For example, the computer system optionally initiates a simulated drawing at a location targeted by attention of the user, and optionally draws additional portions of the simulated drawing in accordance with movement of an air pinch. Additionally or alternatively, the computer system optionally detects speech concurrent with the simulated marking, such as a circling of a location on a map while the user speaks about meeting at the circled location.

In some embodiments, in response to detecting the first input, in accordance with the determination that the respective region is the first region, the computer system associates second information corresponding to the virtual annotation with a respective first region of the first supplemental map, such as associating annotation 740 with first supplemental map 786 as shown in FIG. 7L. For example, without detecting one or more additional or alternative intervening inputs and/or without detecting a designation of a specific data format (e.g., a voice command requesting a photograph, selection of a button to initiate the user's voice, and/or a selection of a button to initiate a video recording). For example, the computer system optionally detects the user's voice, one or more images of the user's environment, virtual handwriting performed by detecting movement of a computing peripheral (e.g., an oblong pointing device and/or a mouse) in communication with the computer system, virtual handwriting performed by a maintained air gesture (e.g., while an air pinch, an air pointing, and/or an air fist pose is maintained) and stores and/or associates the recording of the user's voice, the image(s), and/or the virtual handwriting with the first supplemental map. When presenting the maps user interface and/or the first supplemental map, the computer system optionally presents a representation (e.g., an icon, the one or more images, and/or text) corresponding to the second information at a position relative to the first supplemental map. The position of the representation (e.g., included in the respective first region of the first supplemental map) of the second information optionally is and/or corresponds to the user's location when the computer system detected the first input. Thus, the computer system optionally maps locations of the user's virtual annotations directed toward physical features to virtual content included in the first supplemental map. As an example, the computer system optionally detects and/or displays a virtual annotation overlaying a representation of a physical door while detecting information for the supplemental map (e.g., in response to user input providing the annotation), and when displaying the supplemental map at a later time, displays the virtual annotation overlaying a virtual reproduction of the physical door included in the immersive reproduction of spatial information included in the supplemental map. In some embodiments, the computer system overlays the second information (e.g., handwriting, a static image, a thumbnail, and/or video) over the respective region of the first supplemental map.

In some embodiments, in response to detecting the first input, in accordance with the determination that the respective region is the second region, the computer system associates the second information corresponding to the virtual annotation with a respective second region of the first supplemental map, such as associating annotation 740 with second supplemental map 782 as shown in FIG. 7L. For example, when the user's viewpoint relative to the three-dimensional environment corresponds to the second region (and/or not the first region) the computer system optionally stores and/or associates the second information with a corresponding portion of the first supplemental map (e.g., the respective second region). When presenting the first supplemental map, the computer system optionally forgoes presentation of the second information and/or a representation of the second information at the respective first region of the first supplemental map, and optionally displays the second information and/or the representation of the second information at the respective second region of the first supplemental map. Associating information corresponding to the virtual annotation with a respective region of the first supplemental map improves annotation placement relative to the first supplemental map, thus reducing processing require to detect inputs moving an annotation relative to the first supplemental map.

In some embodiments, while a representation of a respective second region of the physical environment of the computer system is visible via the display generation component, the computer system detects, via the one or more input devices, a second input, different from the first input, such as an input similar to or the same as voice command 722 as shown in FIG. 7A. For example, the second input optionally has one or more characteristics similar to or the same as the first input. Additionally or alternatively, the respective second region of the physical environment optionally has one or more characteristics similar to or the same as the respective region described with reference to method 800.

In some embodiments, in response to detecting the second input (e.g., similar to or the same as operations performed in response to the first input), in accordance with a determination that the respective region is a third region, associating third information that is associated with the third region with the first supplemental map, wherein the second input does not indicate the third information associated with the third region, such as a supplemental map corresponding to a portion of map shown in virtual object 778 as shown in FIG. 7L.

In some embodiments, in response to detecting the second input (e.g., similar to or the same as operations performed in response to the first input), in accordance with a determination that the respective region is a fourth region, different from the third region, the computer system associates fourth information that is associated with the fourth region with the first supplemental map, wherein the second input does not indicate the fourth information associated with the fourth region, and wherein the fourth information is different from the third information, such as a supplemental map corresponding to a portion of map shown in virtual object 778 as shown in FIG. 7L. In some embodiments, the third region and/or the fourth region have one or more characteristics similar to or the same as the first region and/or the second region. Additionally or alternatively, the second input optionally does not indicate respective information that will be associated with the first supplemental map, similar to or the same as described with reference to the first input. Thus, the computer system optionally associates information with the first supplemental map in response to detecting another input than the first input. In some embodiments, the computer system performs operations to associate the different information with the first supplemental map based upon satisfaction of the one or more criteria described previously. Therefore, the computer system optionally is able to repeatedly associate information with the first supplemental map, and optionally is also capable of presenting the various pieces of information when presenting the first supplemental map. Associating additional or alternative information with the first supplemental map reduces user input required to specify a relationship between a region of the physical environment and the first supplemental map, enhancing the amount of information included in the first supplemental map, and reducing user input required to define a relationship between the first supplemental map and the additional or alternative information, thereby reducing power consumption of the computer system required to process the user input.

In some embodiments, while a viewpoint of a user is a first viewpoint relative to the three-dimensional environment (e.g., the viewpoint of the user is similar to or the same as the viewpoint(s) of the user described herein), the computer system detects, via the one or more input devices, a second input including a request to display a representation of the first supplemental map, such as an input requesting a change in level of immersion, such as a rotating of button 724 (shown in FIG. 7B) while attention is directed to layer 748 as shown in FIG. 7H. For example, the second input and/or the request to display the representation of the first supplemental map has one or more characteristics of the second input and/or the first representation of the first supplemental map described with reference to displaying the representation with a level of immersion. In some embodiments, the information that is associated with the first supplemental—such as in response to the first input described with reference to method 800—is used to display virtual content included in the representation of the first supplemental map.

In some embodiments, while a viewpoint of a user is the first viewpoint relative to the three-dimensional environment (e.g., the viewpoint of the user is similar to or the same as the viewpoint(s) of the user described herein), and in response to detecting the second input, the computer system displays, via the display generation component, the representation of the first supplemental map at a level of immersion relative to the three-dimensional environment that is greater than a threshold level of immersion, such as display of the supplemental map within three-dimensional environment 700 as shown in FIG. 7I. For example, the computer system optionally displays the representation of the first supplemental map consuming portion(s) of the three-dimensional environment as described further herein. A threshold level of immersion, for example, optionally includes one or more a percentage of a viewport consumed by the representation of the first supplemental map (e.g., 50%, 60%, 70%, 80%, 90%, or 100%), a level of opacity of the representation (e.g., 50%, 60%, 70%, 80%, 90%, or 100%), a perceived width and/or height of where the representation consumes the viewport, and/or some combination thereof.

In some embodiments, while displaying the representation of the first supplemental map at the level of immersion relative to the three-dimensional environment that is greater than the threshold level of immersion, the computer system detects a change in the viewpoint of the user, such as movement of the viewpoint of user 704 from as shown in FIG. 7J to as shown in FIG. 7K. For example, the change in viewpoint has one or more characteristics similar to or the same as detecting other change(s) of the viewpoint of the user described further herein.

In some embodiments, in response to detecting the change in the viewpoint of the user, the computer system changes the representation of the first supplemental map at the level of immersion greater than the threshold level of immersion in accordance with the detected change in the viewpoint of the user, such as the changing of three-dimensional environment from as shown in FIG. 7J to as shown in FIG. 7K. For example, the computer system optionally scrolls, pans, rotates, scales (upward or downward), and/or otherwise updates the representation of the first supplemental map in a direction and/or by a magnitude of the change in viewpoint. As described further herein, the computer system optionally displays virtual content while displaying the representation of the supplemental map using information captured by the computer system while generating the supplemental map. For example, the computer system optionally detects the user's body moving in a first direction and/or a second direction, and by a first distance and/or a second distance (e.g., first and/or second magnitude). In response to detecting such changes in the viewpoint, the computer system optionally updates the displayed representation of the first supplemental map, displaying image(s) simulating the user physically moving through the physical environment (e.g., by the first, second, and/or a third magnitude and/or in a first, second, and/or third direction based upon the first and second magnitude(s) and/or direction(s)). In some embodiments, in response to detecting the change in viewpoint, the computer system updates the displayed three-dimensional environment as though the user were physically moving through the physical environment. In some embodiments, the portions of the representation of the first supplemental map are displayed based upon one or more images that were detected by the computer system and were beyond viewport of the computer system when the first input was detected. For example, the computer system optionally images the physical environment behind the user's head prior to and/or in response to detecting the first input. When displaying a maps user interface including the representation of the first supplemental map, the computer system optionally facilitates display of the images of a region of the physical environment that were behind the user's head, even if the user had not directed the computer system viewport toward that region. In some embodiments, the computer system maintains the level of immersion of the representation of the first supplemental map in response to detecting the change in the viewpoint. Changing the representation of the first supplemental map in response to detecting changes in the user's viewpoint relative to the three-dimensional environment frees the user to concurrently provide additional or alternative inputs directed to a maps user interface, thereby reducing processing power required to sequentially change the representation of the first supplemental map and thereafter detect inputs directed to the maps user interface.

In some embodiments, the first supplemental map is obtained from a respective computer system, different from the computer system, such as a computer system including circuitry similar to, or the same as computer system 101 shown in FIG. 7A. For example, the computer system optionally obtains the first supplemental map and/or information included in the first supplemental map from a computer system that has one or more characteristics similar to or the same as the computer system. For example, the computer system and the other computer system optionally are both head-mounted devices, optionally both include circuitry required to detect images and/or spatial data of the environment, optionally both include circuitry required to display representations of the environment and/or the first supplemental map at a level of immersion greater than a threshold level of immersion, and/or optionally both include circuitry required to track the position and/or orientation of portion(s) of the user's body. In some embodiments, the computer system is capable of exporting the first supplemental map to the other computer system, such as communicating information included in the first supplemental map to the other computer system. In some embodiments, the computer system receives the supplemental map from another computer system. In some embodiments, the computer system is able to display a representation of the supplemental map, despite not being co-located with the other device and/or never physically visiting the location corresponding to the received supplemental map, in a manner similar to or the same as described with reference to displaying a supplemental map generated by the computer system herein. Thus, the computer system optionally uses information from the other computer system that recorded the information to display an immersive mapping experience. Obtaining the first supplemental map from the respective computer system reduces storage required to hold the first supplemental map in memory before the computer system requires the first supplemental map, thereby freeing the memory to store additional or alternative information.

In some embodiments, while a representation of a respective second region of the physical environment of the computer system is visible via the display generation component, the computer system detects, via the one or more input devices, that one or more criteria are satisfied, wherein the one or more criteria are satisfied without detecting an input requesting association of respective information with the first supplemental map, such as movement of the viewpoint of user 704 from as shown in FIG. 7A to 7B. For example, the computer system associates respective information with the first supplemental map without detecting a voice command, a selection of a physical and/or virtual button, a movement of a rotational crown button, a touching of a surface (e.g., a non-touch sensitive surface and/or a touch-sensitive surface monitored by the computer system), and/or an air gesture expressly requesting the association. Thus, the computer system optionally frees the user to move about and interact with their three-dimensional environment and is optionally configured to capture and associate information with the first supplemental map without requiring express inputs requesting such capture and/or association. In some embodiments, the computer system associates the respective information when one or more criteria are satisfied, such as when the one or more criteria are satisfied described with reference to method 800. For example, the computer system optionally determines and/or obtains an indication from another computer system that the user reaches and/or moves around a significant location, and in response associates the respective information such as the first and/or second information with the first supplemental map. Additionally or alternatively, the one or more criteria optionally include a criterion that is satisfied when the viewpoint of the user is within a threshold distance (e.g., 0.01, 0.05, 0.1, 0.25, 0.5, 0.75, 1, 1.5, 3, or 5 m) of a particular region, landmark, and/or other significant location described further with reference to method 800. In some embodiments, the one or more criteria include a criterion that is satisfied when the user is moving along a well-known route such as a common walking trail and/or include a criterion that is satisfied when the user transitions from moving to remaining within a region. In some embodiments, the one or more criteria include a criterion that is satisfied when the computer system detects, via the one or more input devices, that an element included in a three-dimensional environment is involved in an interaction with a user of the computer system (e.g., another individual is talking to the user, the user is talking to the individual, the other individual is looking toward the user, the user is looking toward the individual). In some embodiments, the one or more criteria include a criterion that is satisfied when a user of the computer system moves within a threshold distance (e.g., 0.01, 0.05, 0.1, 0.25, 0.5, 0.75, 1, 1.5, 3, or 5 m) of a physical feature such as a physical object, a popular lookout point that other users of other devices indicated as interesting, an item owned by the user such as a vehicle, and/or that the user is entering or leaving a notable location (e.g., a workplace, a home, a dwelling of a contact in the user's list of contacts, and/or a landmark).

In some embodiments, in response to detecting the satisfaction of the one or more criteria, in accordance with a determination that the respective region is a third region, the computer system associates third information that is associated with the third region with the first supplemental map, such as storing spatial information corresponding to building 706 shown in FIG. 7B. For example, the computer system optionally associates third information corresponding to the third region with the first supplemental map. In some embodiments, the third information has one or more characteristics that are similar to or the same as described with reference to the first and/or second information.

In some embodiments, in response to detecting the satisfaction of the one or more criteria, and in accordance with a determination that the respective region is a fourth region, different from the third region, the computer system associates fourth information that is associated with the fourth region with the first supplemental map, wherein the fourth information is different from the third information, such as associating the spatial information corresponding to statue 710 with the first supplemental map, as shown in FIG. 7D. For example, the computer system optionally associates fourth information corresponding to the fourth region with the first supplemental map. In some embodiments, the fourth information has one or more characteristics that are similar to or the same as described with reference to the first, second, and/or third information. In some embodiments, when the one or more criteria are not satisfied, the computer system forgoes association of the third and/or fourth information with the first supplemental map. Associating third and/or fourth information with the first supplemental map when one or more criteria are satisfied without detecting an input expressly requesting the association between the information and the first supplemental map reduces the user input required to request such association, thus freeing the user to interact with the three-dimensional environment and thereby reducing processing and power consumption required to perform operations in response to the input.

In some embodiments, in accordance with a determination that one or more first criteria are satisfied, wherein the one or more first criteria are satisfied without detecting an input requesting association of a respective type of respective information with the first supplemental map, the first information is a first type of information, such as spatial and/or video recording of movement of viewpoint of user 704 from as shown in FIG. 7A through 7E. For example, the type of information and/or data stored in memory at the computer system and/or associated with the first supplemental map is optionally based upon the satisfaction of the one or more criteria. As an example, the computer system optionally determines that the first information will be spatial data mapping the user's movement through the three-dimensional environment when the computer system is moving along a well-known hiking trail and/or along a famous roadway. Additionally or alternatively, the first type of the first information is optionally immersive video that includes images of the three-dimensional environment surrounding the user. Thus, in some embodiments, the computer system captures particular type(s) of information when the one or more first criteria are satisfied and/or without detecting an input expressly requesting association of information with the first supplemental map. In some embodiments, when the one or more first criteria are satisfied, the computer system forgoes storing of a second type of information as described further below.

In some embodiments, the computer system captures one or more of the types of information without prompting and/or requiring the user to select a type of data to store. For example, the input optionally is a generic input such as pressing of a button or a voice command to “record that.” In response to detecting the generic input, the computer system optionally determines whether collecting spatial data, video data, and/or a static image corresponds to a user's current context relative to the three-dimensional environment. As an example, the computer system optionally detects a pressing of a button, and when another individual is speaking, records audio. The computer system optionally detects the pressing of the button while the other individual is not speaking, and the user is gazing toward a landmark; in response to detecting the pressing, the computer system optionally records a spatial video of their surroundings (e.g., without audio). Additionally or alternatively, the computer system optionally determines the type of information to be captured in accordance with environmental factors. For example, the computer system optionally records accelerometer data when the computer system moves along a bike path. Additionally or alternatively, the computer system optionally records stereo video when the user is detected to be walking during daytime (and/or optionally forgoes recording of the stereo video in favor of recording audio during night time).

It is understood that the computer system optionally determines that the second, third, and/or fourth information described herein optionally is the first or the second type in accordance with the determination that the one or more first criteria are-or are not-satisfied.

In some embodiments, in accordance with a determination that the one or more first criteria are not satisfied, the first information is a second type of information, different from the first type of information, such as accelerometer and/or kinematic information about the movement of the viewpoint of the user 704 from FIG. 7A through 7E. For example, the computer system optionally captures the second type of information in response to detecting an express request to capture such information. As examples, the second type of information is optionally an image of the user's viewport when a physical and/or virtual button are selected, is optionally immersive video when the physical and/or virtual buttons are selected for a period of time greater than a threshold period of time (e.g., 0.05, 0.1, 0.5, 1, 1.5, 2, 3, 5, or 10 seconds), is optionally a voice recording when a voice command is detected, is optionally spatial data capturing spatial data mapping the physical features of a physical object in response to an air gesture, and/or some combination thereof. Thus, in some embodiments, the computer system captures particular type(s) of information when the one or more first criteria are not satisfied and/or in response to detecting an input expressly requesting association of information with the first supplemental map. In some embodiments, when the one or more first criteria are not satisfied, the computer system forgoes storing of the first type of information. Associating a first and/or a second type of information with the first supplemental map at least partially based upon the satisfaction of criteria improves the user's ability to include specific information of their interest in the first supplemental map, thus reducing user input complexity required to specify types of information to include in the first supplemental map.

In some embodiments, the first input includes a voice command provided by a user of the computer system, such as voice command 722 as shown in FIG. 7A. For example, the computer system optionally detects a keyword phrase (e.g., “Hello voice assistant, capture a memory” and/or “Please capture my experiences”) and optionally adds the first and/or second information to the first supplemental map. Additionally or alternatively, the computer system optionally ceases detection of information in response to a voice command requesting as such. Capturing information that is associated with the first supplemental map in response to detecting a voice command frees the user to provide additional or alternative inputs via other input modalities, optionally concurrently while providing the voice command, thereby simplifying and improving user-computer interaction efficiency.

In some embodiments, the first information includes information corresponding to a traversed route of a user of the computer system moving within the respective region, such as the movement from FIG. 7A through FIG. 7E. For example, as described with reference to method 800, the computer system optionally includes spatial data and/or information that plots the user's movement through the first, second, and/or another region of the three-dimensional environment (e.g., GPS, accelerometer, location, and/or orientation data). While displaying a maps user interface including the first supplemental map, the computer system optionally displays a representation of their route, as described further herein. In some embodiments, the route is displayed overlaying a mini-map, which is optionally a two-dimensional virtual object that includes a map of the three-dimensional environment and a highlighted route that the user previously traversed using the first information. It is understood that other information associated with the first supplemental map described herein is optionally displayed by the computer system, such as the second information described with reference to method 800. In some embodiments, the spatial data recorded by the computer system does not include spatial data corresponding to periods of time when the user is not moving along a known route, such as a walking path, a bicycle path, a scenic road, and/or a walking tour of a city. Mapping a route of the user's movement through region(s) of the three-dimensional environment reduces the need for the user to further interact with a mapping user interface in an attempt to manually identify their previous movement, thereby reducing power consumption of the computer system to perform operations in accordance with the manual identification.

In some embodiments, the first information includes a plurality of images captured by one or more cameras in communication with the computer system depicting a traversed route of a user of the computer system moving within the respective region, such as images depicting movement of viewpoint of user 704 from FIG. 7A through FIG. 7E. For example, the computer system optionally captures one or more images as described further herein with reference to spatial data and/or immersive video. Such one or more images optionally comprise a video that is taken as the user begins movement and/or stasis within a significant region and/or near a significant location. It is understood that other information described herein optionally also includes one or more images capturing the traversed route of the user moving through the second and/or other regions of the three-dimensional environment described herein. In some embodiments, the computer system forgoes capturing of one or more images when the computer system is not oriented toward a significant location and/or deviates away from a known route (e.g., described above). Including one or more images in the first information reduces the need for detecting input required to expressly request capture of the one or more images, thus reducing operations performed by the computer system and thereby reducing power consumption.

In some embodiments, the computer system detects, via the one or more input devices, a second input including a request to display a representation of the first supplemental map, such as an input causing display of the virtual object 742 as shown in FIG. 7F. For example, the second input optionally has one or more characteristics similar to or the same as described with reference other input(s) herein. In some embodiments, the second input includes selection via an air gesture, a selection of a button, and/or a voice command directed to a visual representation of the first supplemental, such as an icon, a photograph, video, and/or text corresponding to the first supplemental map.

In some embodiments, in response to detecting the second input, the computer system concurrently displays, via the display generation component, a representation of a primary map associated with the respective region, such as one or more inputs provided by hand 406 as shown from FIG. 7F through 7H causing display of the map included in virtual object 742. For example, the representation of the primary map has one or more characteristics similar to or the same as those described with reference to the primary map and/or representation(s) of the primary map described with reference to method 800.

In some embodiments, in response to detecting the second input, the computer system additionally (concurrently with the representation of the primary map) displays the representation of the first supplemental map, wherein one or more visual indications associated with the respective region and the first supplemental map overlay the representation of the primary map, such as layer 748 as shown in FIG. 7H. For example, the representation of the first supplemental map has one or more characteristics similar to or the same as those of the supplemental map and/or representation(s) of the supplemental map described with reference to method 800. Concurrently displaying the representations of the primary map and the supplemental map presents the user with an information-rich user interface, reducing the need for inputs cross-referencing information included in the supplemental map against the representation of the primary map, thus reducing user input and power consumption required to perform operations facilitating the cross-referencing and/or facilitating separate display of the representations of the primary and the supplemental maps.

In some embodiments, the first supplemental map is configured to be displayed by the computer system as a three-dimensional representation of the first supplemental map, such as shown in three-dimensional environment 700 as shown in FIG. 7I. In some embodiments the first supplemental map is configured to be displayed by an alternative computer system, different from the computer system, as a two-dimensional representation of the first supplemental map, such as electronic device 500 displaying user interface 711 as shown in FIG. 7N. For example, the first supplemental map includes data, information, types of data, and/or formats of data such that different types of computer systems having varying characteristics are capable of presenting different views of the first supplemental map. As an example, in accordance with a determination that the computer system has first one or more characteristics (e.g., is capable of displaying virtual content at a level of immersion greater than a threshold level of immersion), the computer system optionally displays the first supplemental map including one or more three-dimensional objects and/or textures. The computer system in such examples is optionally a head-mounted device, similar to or the same as described further herein. In accordance with a determination that the computer system has second one or more characteristics, different from the first one or more characteristics (e.g., is not capable of displaying the virtual content at the level of immersion greater than the threshold level of immersion), the computer system optionally forgoes display of one or more three-dimensional environment objects and/or textures. In some embodiments, the computer system having the second one or more characteristics displays the first supplemental map not including some or all of the one or more three-dimensional environment objects and/or textures (e.g., forgoes display of such three-dimensional features). For example, the computer system having the second one or more characteristics is optionally a mobile phone, a tablet, and/or a laptop computer and optionally presents a two-dimensional representation, such as a planar map. Thus, the computer system optionally displays the first supplemental map with a level of immersion greater than the threshold level of immersion further herein, and a device receiving the first supplemental map (e.g., that has the second or more characteristics) forgoes and/or is not capable of displaying the first supplemental map with a level of immersion (e.g., displays the supplemental map with no immersion). Configuring the first supplemental map for display including a two-dimensional or a three-dimensional representation reduces storage required to separately hold multiple types of representation of the first supplemental map in memory.

It should be understood that the particular order in which the operations in method 800 have been described is merely exemplary and is not intended to indicate that the described order is the only order in which the operations could be performed. One of ordinary skill in the art would recognize various ways to reorder the operations described herein.

The flowchart and block diagrams in the FIGs. illustrate the architecture, functionality, and operation of possible implementations of systems, methods, and computer readable media according to various examples of the present disclosure. In this regard, each block in the flowchart or block diagrams may represent a module, segment, or portion of instructions, which comprises one or more executable instructions for implementing the specified logical function(s) as described herein. In some implementations, the functions noted in the blocks may occur out of the order shown and noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

What is claimed is:

1. A method comprising:
at computer system in communication with one or more input devices and a display generation component:
while a representation of a respective region of a physical environment included in a three-dimensional environment of the computer system is visible via the display generation component, detecting, via the one or more input devices, a first input; and
in response to detecting the first input:
in accordance with a determination that the respective region is a first region, associating first information that is associated with the first region with a first supplemental map, wherein the first input does not indicate the first information associated with the first region; and
in accordance with a determination that the respective region is a second region, different from the first region, associating second information that is associated with the second region with the first supplemental map, wherein the first input does not indicate the second information associated with the second region, and wherein the second information is different from the first information.

2. The method of claim 1, further comprising:
after associating information with the first supplemental map in response to detecting the first input, detecting, via the one or more input devices, a second input, different from the first input; and
in response to detecting the second input:
displaying a first representation of the first supplemental map, wherein the first representation is displayed with a level of immersion that is greater than a threshold level of immersion relative to the three-dimensional environment, including:
in accordance with the determination that the respective region is the first region, presenting the first information; and
in accordance with the determination that the respective region is the second region, different from the first region, presenting the second information, different from the first information.

3. The method of claim 2, further comprising:
displaying, via the display generation component, a maps user interface including a visual indication corresponding to the first supplemental map, wherein the second input includes selection of the visual indication.

4. The method of claim 2, further comprising:
displaying, via the display generation component, a maps user interface including a visual indication corresponding to the respective region, wherein the second input is directed toward the visual indication corresponding to the respective region.

5. The method of claim 2, further comprising:
displaying, via the display generation component, a maps user interface including a visual indication corresponding to respective information associated with the first supplemental map, wherein:
in accordance with the determination that the respective region is the first region, the visual indication is a first visual indication corresponding to the first information,
in accordance with the determination that the respective region is the second region, the visual indication is a second visual indication corresponding to the second information, and
the second input is directed toward the visual indication corresponding to the respective region.

6. The method of claim 1, further comprising:
detecting, via the one or more input devices, spatial audio, wherein associating the first supplemental map with the first information includes including the spatial audio in information used to generate the first supplemental map, and associating the first supplemental map with the second information includes including the spatial audio information used to generate the first supplemental map.

7. The method of claim 6, further comprising:
displaying, via the display generation component, a representation of the first supplemental map wherein the representation is presented based on a viewpoint of a user of the computer system that is a first viewpoint; and
while displaying the representation of the first supplemental map and while the viewpoint of the user is the first viewpoint:
generating respective first spatial audio corresponding to the spatial audio that is associated with the first supplemental map in response to detecting the first input; and
detecting, via the one or more input devices, a change in the viewpoint of the user to a second viewpoint different from the first viewpoint;
in response to detecting the change in viewpoint to the second viewpoint:
presenting, via the display generation component, the representation of the first supplemental map relative to the second viewpoint; and
generating respective second spatial audio, different from the respective first spatial audio, corresponding to the spatial audio that is associated with the first supplemental map in response to detecting the first input.

8. The method of claim 1, wherein:
in accordance with a determination that a viewpoint of a user of the computer system is a first viewpoint when the first input is detected, the first information is respective first information; and
in accordance with a determination that the viewpoint of the user of the computer system is a second viewpoint, different from the first viewpoint, when the first input is detected, the first information is respective second information, different from the respective first information.

9. The method of claim 1, further comprising:
detecting, via one or more cameras in communication with the computer system, one or more images, wherein the one or more images correspond to a viewpoint of a user of the computer system relative to the three-dimensional environment, wherein:
the first information includes respective one or images of the first region of the physical environment that are included in the one or more images, and
the second information includes respective one or more images of the second region of the physical environment that are included in the one or more images.

10. The method of claim 1, further comprising:
wherein the first input includes a request to include a virtual annotation in the three-dimensional environment, the method further comprising:
in response to detecting the first input:
in accordance with the determination that the respective region is the first region, associating second information corresponding to the virtual annotation with a respective first region of the first supplemental map; and
in accordance with the determination that the respective region is the second region, associating the second information corresponding to the virtual annotation with a respective second region of the first supplemental map.

11. The method of claim 1, further comprising:
while a representation of a respective second region of the physical environment of the computer system is visible via the display generation component, detecting, via the one or more input devices, a second input, different from the first input; and
in response to detecting the second input:
in accordance with a determination that the respective region is a third region, associating third information that is associated with the third region with the first supplemental map, wherein the second input does not indicate the third information associated with the third region; and
in accordance with a determination that the respective region is a fourth region, different from the third region, associating fourth information that is associated with the fourth region with the first supplemental map, wherein the second input does not indicate the fourth information associated with the fourth region, and wherein the fourth information is different from the third information.

12. The method of claim 1, further comprising:
while a viewpoint of a user is a first viewpoint relative to the three-dimensional environment:
detecting, via the one or more input devices, a second input including a request to display a representation of the first supplemental map;
in response to detecting the second input, displaying, via the display generation component, the representation of the first supplemental map at a level of immersion relative to the three-dimensional environment that is greater than a threshold level of immersion; and
while displaying the representation of the first supplemental map at the level of immersion relative to the three-dimensional environment that is greater than the threshold level of immersion, detecting a change in the viewpoint of the user; and
in response to detecting the change in the viewpoint of the user, changing the representation of the first supplemental map at the level of immersion greater than the threshold level of immersion in accordance with the detected change in the viewpoint of the user.

13. The method of claim 1, wherein the first supplemental map is obtained from a respective computer system, different from the computer system.

14. The method of claim 1, further comprising:
while a representation of a respective second region of the physical environment of the computer system is visible via the display generation component, detecting, via the one or more input devices, that one or more criteria are satisfied, wherein the one or more criteria are satisfied without detecting an input requesting association of respective information with the first supplemental map; and
in response to detecting the satisfaction of the one or more criteria:
in accordance with a determination that the respective region is a third region, associating third information that is associated with the third region with the first supplemental map; and
in accordance with a determination that the respective region is a fourth region, different from the third region, associating fourth information that is associated with the fourth region with the first supplemental map, wherein the fourth information is different from the third information.

15. The method of claim 1, wherein:
in accordance with a determination that one or more first criteria are satisfied, wherein the one or more first criteria are satisfied without detecting an input requesting association of a respective type of respective information with the first supplemental map, the first information is a first type of information, and
in accordance with a determination that the one or more first criteria are not satisfied, the first information is a second type of information, different from the first type of information.

16. The method of claim 1, wherein the first input includes a voice command provided by a user of the computer system.

17. The method of claim 1, wherein the first information includes information corresponding to a traversed route of a user of the computer system moving within the respective region.

18. The method of claim 1, wherein the first information includes a plurality of images captured by one or more cameras in communication with the computer system depicting a traversed route of a user of the computer system moving within the respective region.

19. The method of claim 1, further comprising:
detecting, via the one or more input devices, a second input including a request to display a representation of the first supplemental map; and
in response to detecting the second input, concurrently displaying, via the display generation component:
a representation of a primary map associated with the respective region; and
the representation of the first supplemental map, wherein one or more visual indications associated with the respective region and the first supplemental map overlay the representation of the primary map.

20. The method of claim 1, wherein:
the first supplemental map is configured to be displayed by the computer system as a three-dimensional representation of the first supplemental map, and
the first supplemental map is configured to be displayed by an alternative computer system, different from the computer system, as a two-dimensional representation of the first supplemental map.

21. A computer system that is in communication with one or more display generation components and one or more input devices, the computer system comprising:
one or more processors;
memory; and
one or more programs, wherein the one or more programs are stored in the memory and configured to be executed by the one or more processors, the one or more programs including instructions for:
while a representation of a respective region of a physical environment included in a three-dimensional environment of the computer system is visible via the display generation component, detecting, via the one or more input devices, a first input; and
in response to detecting the first input:
in accordance with a determination that the respective region is a first region, associating first information that is associated with the first region with a first supplemental map, wherein the first input does not indicate the first information associated with the first region; and
in accordance with a determination that the respective region is a second region, different from the first region, associating second information that is associated with the second region with the first supplemental map, wherein the first input does not indicate the second information associated with the second region, and wherein the second information is different from the first information.

22. A non-transitory computer readable storage medium storing one or more programs, the one or more programs comprising instructions, which when executed by one or more processors of a computer system that is in communication with a display generation component and one or more input devices, cause the computer system to perform a method comprising:
while a representation of a respective region of a physical environment included in a three-dimensional environment of the computer system is visible via the display generation component, detecting, via the one or more input devices, a first input; and
in response to detecting the first input:
in accordance with a determination that the respective region is a first region, associating first information that is associated with the first region with a first supplemental map, wherein the first input does not indicate the first information associated with the first region; and
in accordance with a determination that the respective region is a second region, different from the first region, associating second information that is associated with the second region with the first supplemental map, wherein the first input does not indicate the second information associated with the second region, and wherein the second information is different from the first information.
